(19) United States
(12) Patent Application Publication
(10) Pub. No.: US 2012/0212825 A1
(43) Pub. Date: Aug. 23, 2012

(54) OPTICAL ELEMENT AND PRODUCTION METHOD THEREOF, DISPLAY APPARATUS, INFORMATION INPUT APPARATUS, AND PHOTOGRAPH

(75) Inventors: Yu Nomura, Miyagi (JP); Hiroyuki Kiso, Miyagi (JP); Fumihiko Iida, Miyagi (JP)

(73) Assignee: Sony Corporation, Tokyo (JP)

(21) Appl. No.: 13/359,672

(22) Filed: Jan. 27, 2012

(30) Foreign Application Priority Data
Feb. 4, 2011 (JP) 2011-023391

(51) Int. Cl. G02B 1/10; B29D 11/00

(52) U.S. Cl. 359/580; 264/1.36

(57) ABSTRACT

An optical element includes a base body having a surface; and a plurality of structures arranged with fine pitches equal to or less than a wavelength of visible light on the surface of the base body, wherein an elastic modulus of a material forming the structure is equal to or greater than 1 MPa and equal to or less than 1200 MPa, an aspect ratio of the structure is equal to or greater than 0.6 and equal to or less than 5, and a coefficient of kinetic friction of the surface of the base body on which the plurality of structures are formed is equal to or less than 0.85.

### BACKGROUND

The present disclosure relates to an optical element and a production method thereof, a display apparatus, an information input apparatus, and a photograph. Specifically, the present disclosure relates to an optical element in which a large number of structures formed of convex portions or concave portions are arranged with fine pitches equal to or less than the wavelength of visible light.

Hitherto, regarding an optical element using a light-transmissive substrate such as glass or plastic, a surface treatment for suppressing surface reflection of light is performed. As for this type of surface treatment, there is a treatment of forming fine and dense concavenesses and convexities (moth-eye) on the surface of an optical element (for example, refer to “OPTICAL AND ELECTRO-OPTICAL ENGINEERING CONTACT”, Vol. 43, No. 11, 2005, pp. 630 to 637).

In general, in a case where periodic concave-convex shapes are provided on the surface of an optical element, diffraction occurs when light is transmitted by the shapes, and a rectilinear propagation component of the transmitted light is significantly reduced. However, in a case where the pitch of the concave-convex shapes is shorter than the wavelength of the transmitted light, diffraction does not occur, and an anti-reflection effect which is effective for a single-wavelength light corresponding to the pitch, depth, or the like of the concave-convex shapes can be obtained. As moth-eye structures forming the concave-convex shapes, structures having various shapes such as bell shapes or truncated elliptical cone shapes have been proposed (for example, refer to Pamphlet International Patent Publication WO 08/023,816).

### SUMMARY

The moth-eye structure as described above is based on the principle that the refractive index is changed in steps by providing fine concavenesses and convexities on the surface thereby suppressing reflection. Therefore, in a case where fingerprints are adhered to the structure, it is preferable that the stains be removed by dry cloth wiping. This is because when the stains such as oil contained in the fingerprints are filled in concave portions between the moth-eye structures, reflection is not suppressed.

When fingerprints are adhered to the moth-eye structures, stains are adhered following the pattern of the fingerprints. Thereafter, the adhered stains infiltrate between the structures due to a capillary phenomenon. Even though dry cloth wiping is performed on the surface in this state, it is difficult to take the stains out of the spaces between the structures.

Infiltration between the structures is suppressed to some extent by coating the surfaces of the structures with a material having a low-surface energy such as fluorine. However, it is difficult to wipe the stains infiltrating between the structures with dry cloth wiping. This is because the concave portion between the structures is thinner than a fiber used for the dry cloth wiping and thus the power of stains to remain in the concave portion between the structures is greater than the power of the fiber to soak up the stains.

It is desirable to provide an optical element capable of wiping stains such as fingerprints adhered to the surface, a production method thereof, a display apparatus, an information input apparatus, and a photograph.

The present inventors studied intensively in order to solve the problems of the related art. As a result, it was found that as the elastic modulus of a material that forms structures is equal to or less than 1200 MPa to cause the structures to have elasticity, the structures were deformed during wiping, and stains such as fingerprints infiltrating between the structures were pushed out and wiped.

However, according to the findings of the present inventors and the like, when the structures were provided with elasticity as described above, the surface thereof became sticky. Therefore, the coefficient of kinetic friction of the surface was high and adjacent structures were adhered to each other, resulting in the degradation of reflection properties. The present inventors studied intensively in order to suppress the degradation of reflection properties. As a result, it was found that as the coefficient of kinetic friction of a structure surface was caused to be equal to or less than 0.85 so as to suppress stickiness of the surface, adhesion of the adjacent structures is suppressed, thereby suppressing the degradation of reflection properties.

The present disclosure was devised according to the above-described study.

An optical element having an anti-reflection function according to a first embodiment of the present disclosure includes: a base body having a surface; and a plurality of structures arranged with fine pitches equal to or less than a wavelength of visible light on the surface of the base body, wherein an elastic modulus of a material forming the structure is equal to or greater than 1 MPa and equal to or less than 1200 MPa, an aspect ratio of the structure is equal to or greater than 0.6 and equal to or less than 5, and a coefficient of kinetic friction of the surface of the base body on which the plurality of structures are formed is equal to or less than 0.85.

An optical element having an anti-reflection function according to a second embodiment of the present disclosure, includes: a plurality of structures arranged with fine pitches equal to or less than a wavelength of visible light, wherein lower portions of the adjacent structures are connected to each other, an elastic modulus of a material forming the structure is equal to or greater than 1 MPa and equal to or less than 1200 MPa, an aspect ratio of the structure is equal to or greater than 0.6 and equal to or less than 5, and a coefficient of kinetic friction of surfaces of the plurality of structures arranged with the fine pitches is equal to or less than 0.85.

A production method of an optical element having an anti-reflection function according to a third embodiment of the present disclosure, includes: causing an energy ray-curable resin composition to come into close contact with a master copy, and illuminating the energy ray-curable resin composition with an energy ray to be cured: and peeling the cured energy ray-curable resin composition from the master copy, thereby forming a plurality of structures arranged with fine pitches equal to or less than a wavelength of visible light on a surface of a base body, wherein an elastic modulus of a material forming the structure is equal to or greater than 1 MPa and equal to or less than 1200 MPa, an aspect ratio of the structure is equal to or greater than 0.6 and equal to or less than 5, and a coefficient of kinetic friction of the surface of the base body on which the plurality of structures are formed is equal to or less than 0.85.

A production method of an optical element having an anti-reflection function according to a fourth embodiment of the present disclosure, includes: causing an energy ray-curable resin composition to come into close contact with a master copy, and illuminating the energy ray-curable resin composition with an energy ray to be cured: and peeling the cured energy ray-curable resin composition from the master copy, thereby forming a plurality of structures arranged with fine pitches equal to or less than a wavelength of visible light, wherein lower portions of the adjacent structures are connected to each other, an elastic modulus of a material forming the structure is equal to or greater than 1 MPa and equal to or less than 1200 MPa, an aspect ratio of the structure is equal to or greater than 0.6 and equal to or less than 5, and a coefficient of kinetic friction of surfaces of the plurality of structures arranged with the fine pitches is equal to or less than 0.85.

The optical element is an optical element having an anti-reflection function and is suitable to be applied to display apparatuses, information input apparatuses, imaging apparatuses, optical systems, and the like.

In the embodiments of the present disclosure, the elliptical, circular (true circle), spherical, ellipsoid shapes include, as well as perfect elliptical, circular, spherical, ellipsoid shapes mathematically defined, elliptical, circular, spherical, ellipsoid shapes to which slight distortion is given.

In the embodiments of the present disclosure, it is preferable that the structures have convex or concave shapes and be arranged into a predetermined lattice pattern. It is preferable that, as the lattice pattern, a tetragonal lattice pattern, a quasi-tetragonal lattice pattern, a hexagonal lattice pattern, or a quasi-hexagonal lattice pattern be used.

In the embodiments of the present disclosure, it is preferable that the arrangement pitch P1 of the structures in the same track is longer than the arrangement pitch P2 of the structures in two adjacent tracks. Consequently, the filling ratio of the structures having an elliptical cone shape or a truncated elliptical cone shape can be enhanced, thereby enhancing the anti-reflection properties.

In the embodiments of the present disclosure, in the case where the structures form the hexagonal lattice pattern or the quasi-hexagonal pattern on the surface of the base body, it is preferable that a ratio P1/P2 satisfy a relationship of 1.00≦P1/P2≦1.1 or 1.00<P1/P2≦1.1, assuming that the arrangement pitch of the structures in the same track is P1 and the arrangement pitch of the structures between two adjacent tracks is P2. In such a numerical range, the filling ratio of the structures having an elliptical cone shape or a truncated elliptical cone shape can be enhanced, thereby enhancing the anti-reflection properties.

In the embodiments of the present disclosure, in the case where the structures form the hexagonal lattice pattern or the quasi-hexagonal pattern on the surface of the base body, it is preferable that the structures have a major axis direction in the extension direction of the track and have the elliptical cone shape or the truncated elliptical cone shape in which the inclination of the center portion is sharper than the inclination of the front end portion and the bottom portion. By employing such a shape, anti-reflection properties and transmission properties can be enhanced.

In the embodiments of the present disclosure, in the case where the structures form the hexagonal lattice pattern or the quasi-hexagonal pattern on the surface of the base body, it is preferable that the height or the depth of the structures in the extension direction of the track be smaller than the height or the depth of the structures in the row direction of the track. In a case where such a relationship is not satisfied, the arrangement pitch in the extension direction of the track has to be lengthened, so that the filling ratio of the structures in the extension direction of the track is reduced. When the filling ratio is reduced as such, degradation of reflection properties is caused.

In the embodiments of the present disclosure, in the case where the structures form the tetragonal lattice pattern or the quasi-tetragonal pattern on the surface of the base body, it is preferable that the arrangement pitch P1 of the structures in the same track be longer than the arrangement pitch P2 of the structures in two adjacent tracks. Consequently, the filling ratio of the structures having an elliptical cone shape or a truncated elliptical cone shape can be enhanced, thereby enhancing the anti-reflection properties.

In the case where the structures form the tetragonal lattice pattern or the quasi-tetragonal pattern on the surface of the base body, it is preferable that P1/P2 satisfy the relationship of 1.4<P1/P2≦1.5, assuming that the arrangement pitch of the structures in the same track is P1 and the arrangement pitch of the structures between two adjacent tracks is P2. In such a numerical range, the filling ratio of the structures having an elliptical cone shape or a truncated elliptical cone shape can be enhanced, thereby enhancing the anti-reflection properties.

In the case where the structures form the tetragonal lattice pattern or the quasi-tetragonal pattern on the surface of the base body, it is preferable that the structures have a major axis direction in the extension direction of the track and have the elliptical cone shape or the truncated elliptical cone shape in which the inclination of the center portion is sharper than the inclination of the front end portion and the bottom portion. By employing such a shape, anti-reflection properties and transmission properties can be enhanced.

In the case where the structures form the tetragonal lattice pattern or the quasi-tetragonal pattern on the surface of the base body, it is preferable that the height or the depth of the structures in a direction at 45 degrees or in a direction at about 45 degrees with respect to the track be smaller than the height or the depth of the structures in the row direction of the track. In a case where such a relationship is not satisfied, the arrangement pitch in the direction at 45 degrees or in a direction at about 45 degrees with respect to the track has to be lengthened, so that the filling ratio of the structures in the direction at 45 degrees or in a direction at about 45 degrees with respect to the track is reduced. When the filling ratio is reduced as such, degradation of reflection properties is caused.

In the embodiments of the present disclosure, it is preferable that a large number of structures arranged on the surface of the base body with fine pitches constitute a plurality of rows of tracks, and regarding the three adjacent lines of tracks, constitute a hexagonal lattice pattern, a quasi-hexagonal lattice pattern, a tetragonal lattice pattern, or a quasi-hexagonal lattice pattern. Accordingly, the filling density of the structures on the surface can be increased, and accordingly, an anti-reflection efficiency of visible light is enhanced, thereby obtaining an optical element having excellent anti-reflection properties and high transmittance.

In the embodiments of the present disclosure, it is preferable that the optical element be produced using a method of combining of a master copy producing process for optical disks and an etching process. A master copy for producing an optical element can be produced within a short time with good efficiency, and an increase in the size of the base body can be compatible. Accordingly, the productivity of the optical element can be enhanced. In addition, in the case where the fine arrangement of the structures are provided not only on a light incident surface but also on a light emitting surface, the transmission properties can be further enhanced.

In the embodiments of the present disclosure, the plurality of structures are arranged with fine pitches equal to or less than the wavelength of visible light, so that reflection of the visible light can be suppressed.

Since the elastic modulus of the material forming the structures is caused to be equal to or greater than 1 MPa, degradation of reflection properties due to the adhesion of adjacent structures can be suppressed. Since the elastic modulus of the material forming the structures is caused to be equal to or less than 1200 MPa, stains infiltrating between the structures can be pushed out and wiped off.

Since the aspect ratio of the structure is caused to be equal to or greater than 0.6, degradation of reflection properties and transmission properties can be suppressed, and since the aspect ratio of the structure is caused to be equal to or less than 5, degradation of the transferability of the structure can be suppressed.

Since the coefficient of kinetic friction of the surface of the structures is equal to or less than 0.85, degradation of reflection properties due to the adhesion of adjacent structures can be suppressed.

As described above, according to the embodiments of the present disclosure, stains such as fingerprints adhered to the surface can be wiped off. In addition, degradation of reflection properties can be suppressed by suppressing the adhesion of adjacent structures.

### BRIEF DESCRIPTION OF THE DRAWINGS

FIG. 1A is a plan view illustrating an example of the configuration of an optical element according to a first embodiment of the present disclosure. FIG. 1B is an enlarged plan view illustrating a part of the optical element illustrated in FIG. 1A. FIG. 1C is a cross-sectional view taken along the tracks T1, T3, . . . of FIG. 1B. FIG. 1D is a cross-sectional view taken along the tracks T2, T4, . . . of FIG. 1B.

FIGS. 2A to 2D are perspective views illustrating shape examples of a structure of the optical element.

FIGS. 3A to 3C are schematic diagrams illustrating an action of the optical element according to the first embodiment of the present disclosure.

FIG. 4A is a perspective view illustrating an example of the configuration of a roll master copy. FIG. 4B is an enlarged plan view illustrating a part of the roll master copy illustrated in FIG. 4A. FIG. 4C is a cross-sectional view taken along the tracks T1, T3, . . . of FIG. 4B. FIG. 4D is a cross-sectional view taken along the tracks T2, T4, . . . of FIG. 4B.

FIG. 5 is a schematic diagram illustrating an example of the configuration of a roll master copy exposure apparatus.

FIGS. 6A to 6D are process diagrams illustrating an example of a production method of the optical element according to the first embodiment of the present disclosure.

FIGS. 7A to 7C are process diagrams illustrating an example of the production method of the optical element according to the first embodiment of the present disclosure.

FIG. 8A is a plan view illustrating an example of the configuration of an optical element according to a second embodiment of the present disclosure. FIG. 8B is an enlarged plan view illustrating a part of the optical element illustrated in FIG. 8A. FIG. 8C is a cross-sectional view taken along the tracks T1, T3, . . . of FIG. 8B. FIG. 8D is a cross-sectional view taken along the tracks T2, T4, . . . of FIG. 8B.

FIG. 9A is a plan view illustrating an example of the configuration of an optical element according to a third embodiment of the present disclosure. FIG. 9B is an enlarged plan view illustrating a part of the optical element illustrated in FIG. 9A. FIG. 9C is a cross-sectional view taken along the line IXC-IXC illustrated in FIG. 9A.

FIG. 10A is a plan view illustrating an example of the configuration of an optical element according to a fourth embodiment of the present disclosure. FIG. 10B is an enlarged plan view illustrating a part of the optical element illustrated in FIG. 10A. FIG. 10C is a cross-sectional view taken along the tracks T1, T3, . . . of FIG. 10B. FIG. 10D is a cross-sectional view taken along the tracks T2, T4, . . . of FIG. 10B.

FIG. 11A is a cross-sectional view illustrating a first example of the configuration of an optical element according to a fifth embodiment of the present disclosure. FIG. 11B is a cross-sectional view illustrating a second example of the configuration of the optical element according to the fifth embodiment of the present disclosure. FIG. 11C is a cross-sectional view illustrating a third example of the configuration of the optical element according to the fifth embodiment of the present disclosure.

FIGS. 12A to 12C are schematic diagrams illustrating an action of a flexible optical element.

FIGS. 13A to 13C are schematic diagrams illustrating an action of a non-flexible optical element.

FIG. 14A is a plan view illustrating an example of the configuration of an optical element according to a sixth embodiment of the present disclosure. FIG. 14B is a cross-sectional view illustrating the example of the configuration of the optical element according to the sixth embodiment of the present disclosure.

FIG. 15 is a cross-sectional view illustrating an example of the configuration of a liquid crystal display apparatus according to a seventh embodiment of the present disclosure.

FIG. 16 is a cross-sectional view illustrating an example of the configuration of a liquid display apparatus according to an eighth embodiment of the present disclosure.

FIG. 17A is an exploded perspective view illustrating an example of the configuration of a display apparatus including an information input apparatus according to a ninth embodiment of the present disclosure. FIG. 17B is a cross-sectional view illustrating an example of the configuration of the information input apparatus according to the ninth embodiment of the present disclosure.

FIG. 18A is an exploded perspective view illustrating an example of the configuration of a display apparatus including an information input apparatus according to a tenth embodiment of the present disclosure. FIG. 18B is a cross-sectional view illustrating an example of the configuration of the information input apparatus according to the tenth embodiment of the present disclosure.

FIG. 19 is a cross-sectional view illustrating an example of the configuration of a photograph with an anti-reflection function according to an eleventh embodiment of the present disclosure.

FIG. 20A is a graph showing the results of a scratch test of optical elements of Samples 7-1 to 7-4. FIG. 20B is a graph showing the results of a scratch test of optical elements of Samples 8-2 to 8-6.

FIG. 21A is a graph showing the results of a scratch test of optical elements of Samples 9-1 to 9-3. FIG. 21B is a graph showing the results of a scratch test of optical elements of Samples 10-2 to 10-7.

FIG. 22 is a schematic diagram illustrating a setting condition of an optical film for simulations.

FIG. 23A is a graph showing the results of simulations in Test Examples 1-1 to 1-10. FIG. 23B is a graph showing the results of simulations in Test Examples 2-1 to 2-4, Test Examples 3-1 to 3-4, and Test Examples 4-1 to 4-4.

FIG. 24 is a schematic diagram illustrating a setting condition of an optical element for simulations.

FIG. 25A is a diagram showing the results of simulations in Test Example 6. FIG. 25B is a graph showing the results of simulations in Test Example 7.

FIG. 26 is a graph showing the results of simulations in Test Examples 8-1 to 8-8.

### DETAILED DESCRIPTION OF EMBODIMENTS

Exemplary embodiments of the present disclosure will be described in the following order with reference to the drawings.

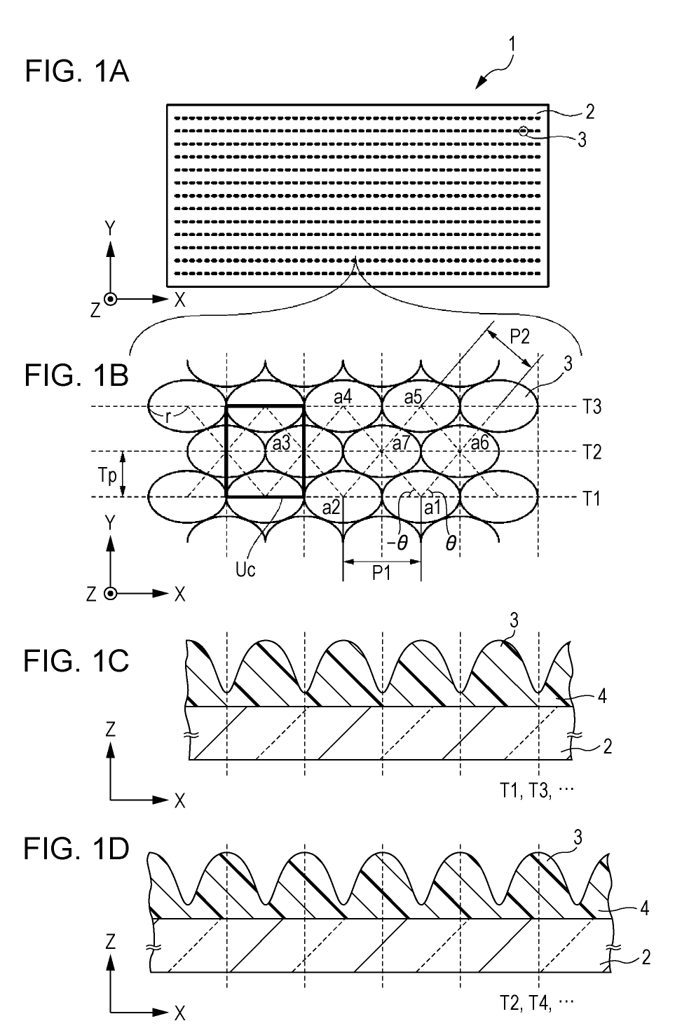

1. First Embodiment (an example of an optical element in which convex structures are arranged into a hexagonal lattice: FIG. 1B)

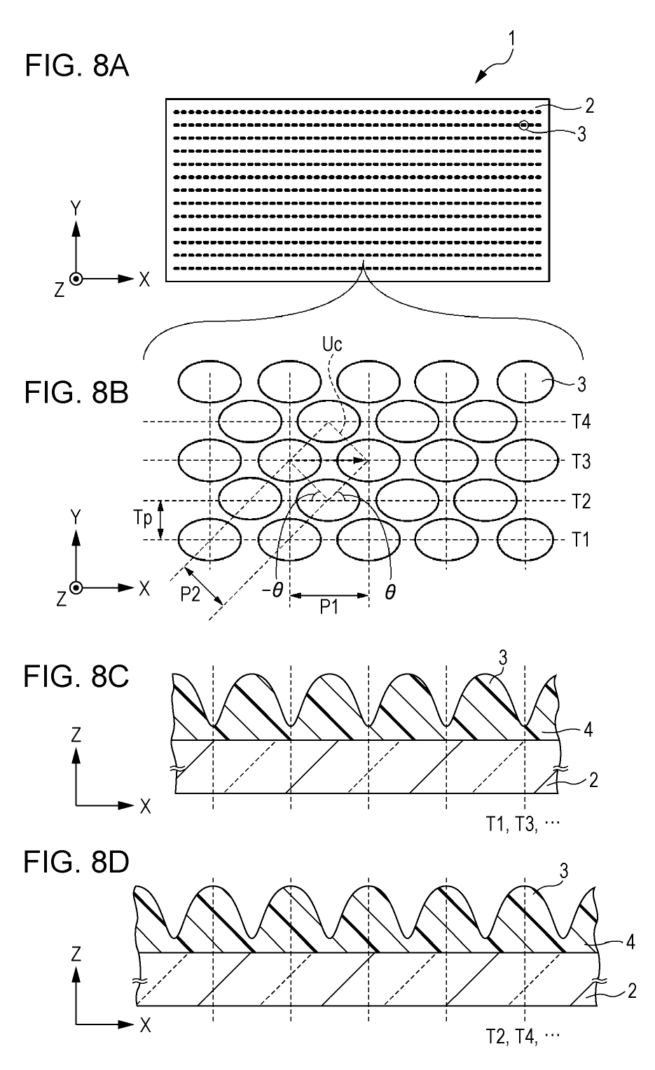

2. Second Embodiment (an example of an optical element in which convex structures are arranged into a tetragonal lattice: FIG. 8B)

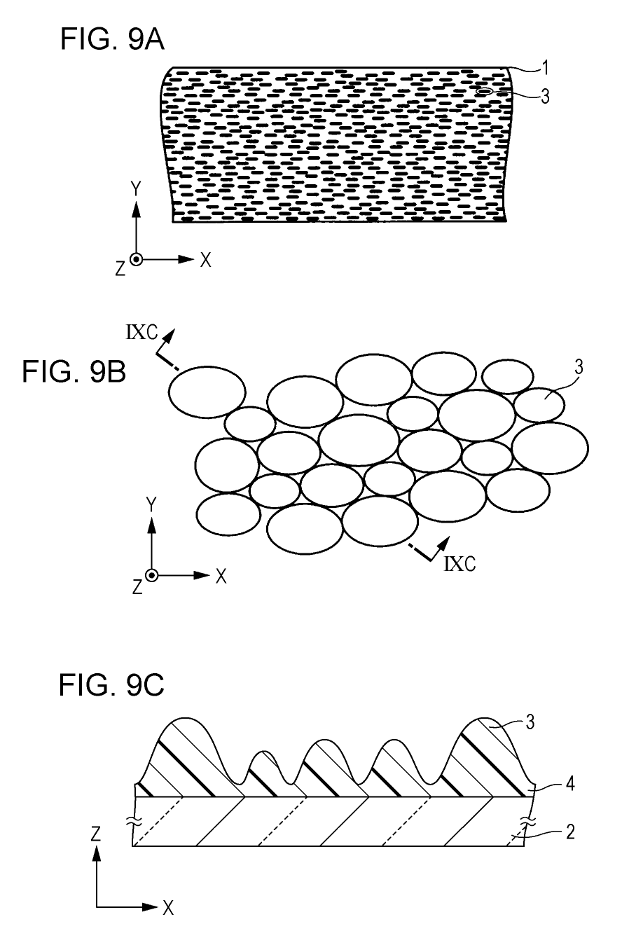

3. Third Embodiment (an example of an optical element in which convex structures are randomly arranged: FIG. 9B)

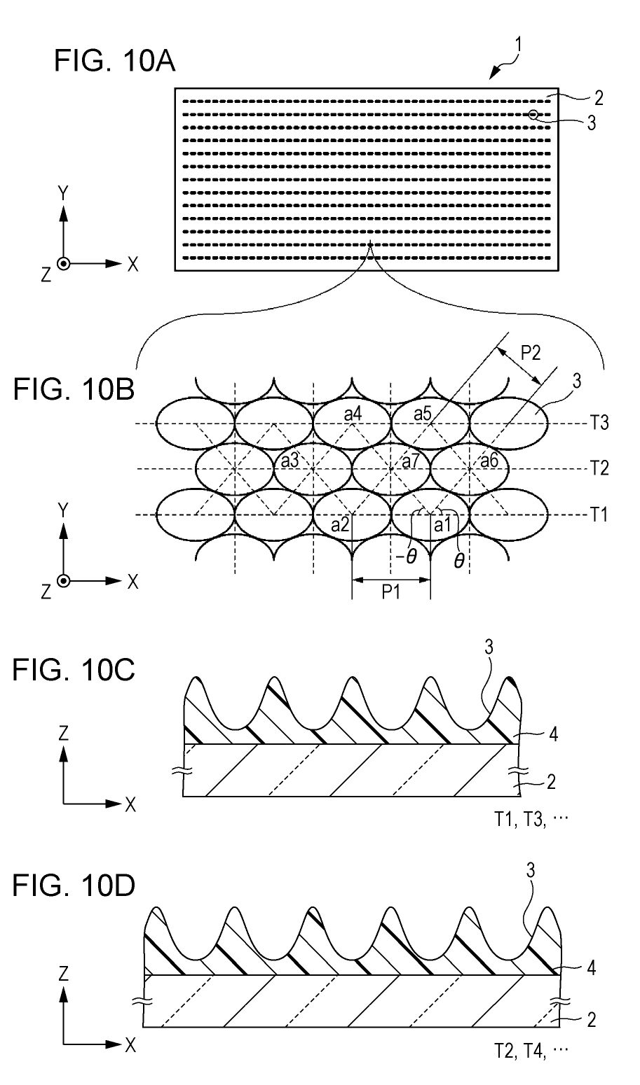

4. Fourth Embodiment (an example of an optical element in which concave structures are arranged into a hexagonal lattice: FIG. 10B)

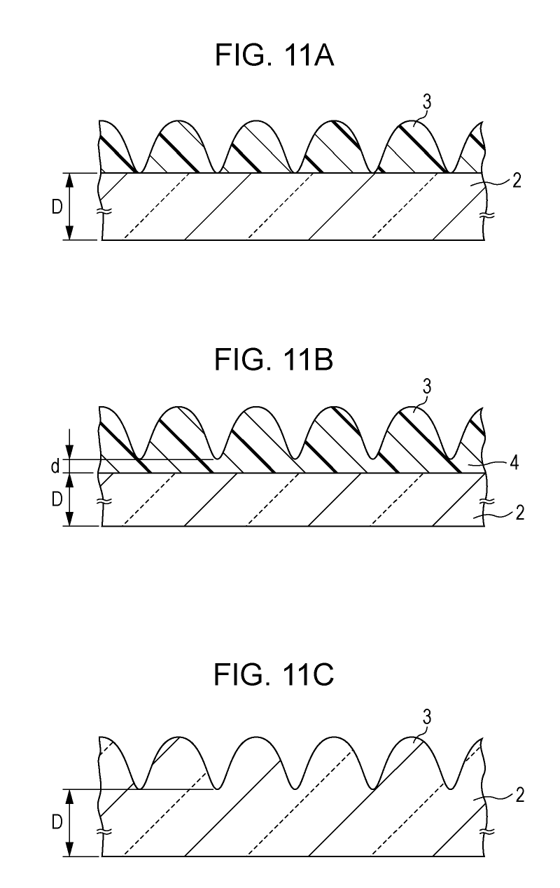

5. Fifth Embodiment (an example of an optical element in which both a base body and structures have flexibility: FIG. 11A)

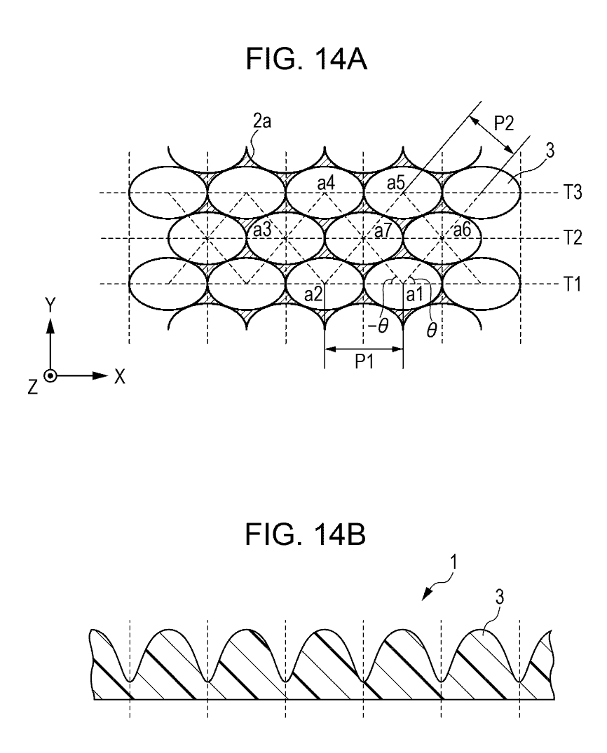

6. Sixth Embodiment (an example of an optical element without a base body: FIG. 14B)

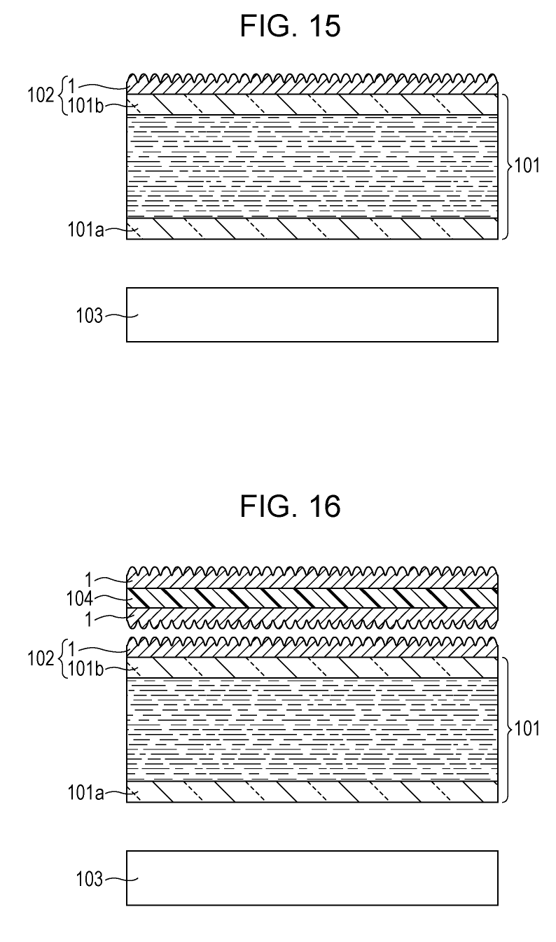

7. Seventh Embodiment (a first application of an optical element for a display apparatus: FIG. 15)

8. Eighth Embodiment (a second application of the optical element for a display apparatus: FIG. 16)

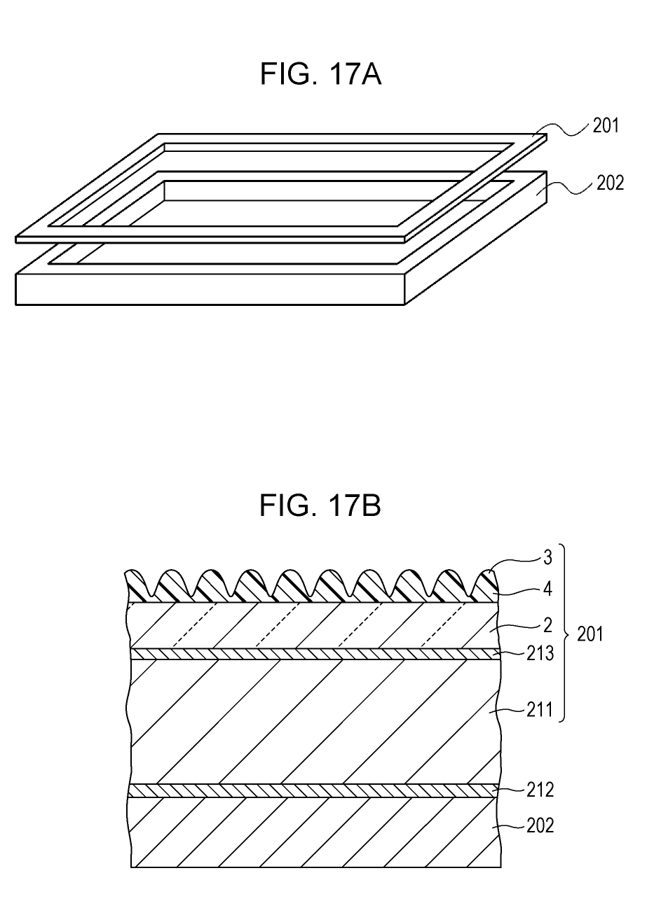

9. Ninth Embodiment (a first application of an optical element for an information input apparatus: FIG. 17B)

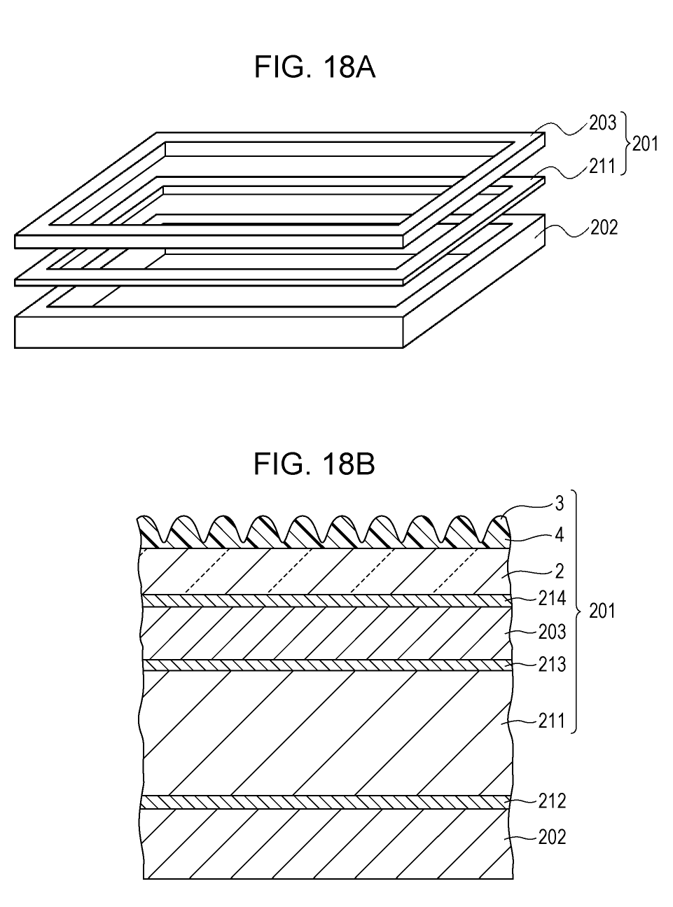

10. Tenth Embodiment (a second application of the optical element for an information input apparatus: FIG. 18B)

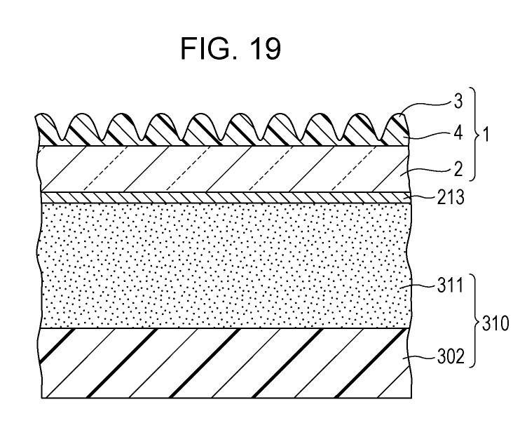

11. Eleventh Embodiment (an application of an optical element for a photograph: FIG. 19)

### 1. First Embodiment

### Configuration of Optical Element

FIG. 1A is a plan view illustrating an example of the configuration of an optical element according to a first embodiment of the present disclosure. FIG. 1B is an enlarged plan view illustrating a part of the optical element illustrated in FIG. 1A. FIG. 1C is a cross-sectional view taken along the tracks T1, T3, . . . of FIG. 1B. FIG. 1D is a cross-sectional view taken along the tracks T2, T4, . . . of FIG. 1B. Hereinafter, two directions that are orthogonal to each other in the plane of a principal surface of an optical element 1 are respectively denoted by a X-axis direction and a Y-axis direction, and a direction perpendicular to the principal surface is denoted by a Z-axis direction.

The optical element 1 includes a base body 2 having the principal surface, and a plurality of structures 3 disposed on the principal surface of the base body 2. The structures 3 and the base body 2 are formed separately or formed integrally with each other. In the case where the structures 3 and the base body 2 are formed separately, a basal layer 4 may be further included between the structures 3 and the base body 2 if necessary. The basal layer 4 is a layer formed integrally with the structures 3 on the bottom surface side of the structures 3 and is made by curing the same energy ray-curable resin composition as the structures 3. It is preferable that the optical element 1 have flexibility. This is because application of the optical element 1 to a surface such as a display surface or an input surface is facilitated thereby.

The base body 2 and the structures 3 included in the optical element 1 will now be sequentially described.

### Base Body

The base body 2 is, for example, a base body having transparency. Examples of the material of the base body 2 include materials mainly containing transparent synthetic resins such as polycarbonate (PC) and polyethylene terephthalate (PET), and glass, and the like as primary components, but the base body 2 is not particularly limited to these materials. Examples of the base body 2 include a sheet, a plate, and a block, and the base body 2 is not particularly limited thereto. Here, it is defined that the sheet includes a film. Although not particularly limited, it is preferable that the shape of the base body 2 is appropriately selected according to the shapes of a surface such as a display surface or an input surface to which the optical element 1 is applied.

### Structure

The structure 3 has, for example, a convex shape with respect to the surface of the base body 2. The elastic modulus of the material forming the structures 3 is equal to or greater than 1 MPa and equal to or less than 1200 MPa. When the elastic modulus is less than 1 MPa, in a transfer process, adjacent structures are adhered to each other, and thus the shape of the structure 3 becomes a shape different from a desired shape, such that desired reflection properties is not obtained. When the elastic modulus exceeds 1200 MPa, adjacent structures do not easily come into contact with each other during wiping, such that stains and the like infiltrating between the structures are not pushed out.

It is preferable that the coefficient of kinetic friction of the surface of the base body on which the plurality of structures 3 are formed be equal to or less than 0.85. When the coefficient of kinetic friction is equal to or less than 0.85, stickiness of the surface can be suppressed, and adhesion of adjacent structures can be suppressed. Therefore, degradation of reflection properties can be suppressed.

It is preferable that the structure 3 contain silicone and urethane. Specifically, it is preferable that the structure 3 be made of a polymer of an energy ray-curable resin composition including silicone acrylate and urethane acrylate. As the structure 3 contains silicone, adhesion of adjacent moth-eye structures and the coefficient of kinetic friction can be reduced. As the structure 3 contains urethane, the structure 3 having flexibility is obtained, so that a material design in a range of 1 MPa to 1200 MPa becomes possible.

The plurality of structures 3 have an arrangement form constituting a plurality of rows of tracks T1, T2, T3, . . . (hereafter collectively referred to as “track T”) on the surface of the base body 2. According to this embodiment of the present disclosure, the track refers to a part in which the structures 3 are lined up in rows. As the shape of the track T, a straight line shape, an arc shape, or the like may be used, and the track T having such a shape wobble (meander). By wobbling the track T as such, an occurrence of unevenness in the outer appearance can be suppressed.

In the case where the track T wobbles, it is preferable that wobbles of the individual tracks on the base body 2 be synchronized. That is, it is preferable that the wobbles are synchronized wobbles. As the wobbles are synchronized, the unit lattice shape of a hexagonal lattice or a quasi-hexagonal lattice is held, so that the filling ratio can be maintained at a high level. Examples of the waveform of the wobbling track T include a sine wave and a triangle wave. The waveform of the wobbling track T is not limited to a periodic waveform, and may be a non-periodic waveform. For example, about ±10 μm is selected as the wobble amplitude of the wobbling track T.

The structures 3 are arranged so that the positions thereof are shifted by a half pitch between two adjacent tracks T. Specifically, regarding the two adjacent tracks T, at an intermediate position (a position shifted by a half pitch) of the structures 3 arranged in the one track (for example, T1), the structure 3 of the other track (for example, T2) is disposed. As a result, as illustrated in FIG. 1B, regarding the three adjacent rows of tracks (T1 to T3), the structures 3 are arranged so as to form a hexagonal lattice pattern or a quasi-hexagonal lattice pattern in which the centers of the structures 3 are located at respective points a1 to a7.

Here, as the hexagonal lattice, the hexagonal lattice refers to a lattice having a regular hexagonal shape. The quasi-hexagonal lattice refers to a lattice having a distorted regular hexagonal shape, unlike the lattice having a regular hexagonal shape. For example, in the case where the structures 3 are arranged on a straight line, the quasi-hexagonal lattice refers to a hexagonal lattice obtained by stretching a lattice having a regular hexagonal shape in an arrangement direction of the straight line shape (track direction) so as to be distorted. In the case where the structures 3 are arranged meanderingly, the quasi-hexagonal lattice refers to a hexagonal lattice obtained by distorting a lattice having a regular hexagonal shape according to the meandering arrangement of the structures 3, or a hexagonal lattice obtained by stretching a lattice having a regular hexagonal shape in the arrangement direction of the straight line shape (track direction) so as to be distorted and then distorting the lattice according to the meandering arrangement of the structures 3.

In the case where the structures 3 are arranged to form a quasi-hexagonal lattice pattern, as illustrated in FIG. 1B, it is preferable that the arrangement pitch P1 (for example, the distance between a1 and a2) of the structures 3 in the same track (for example, T1) is longer than the arrangement pitch of the structures 3 in two adjacent tracks (for example, tracks T1 and T2), that is, the arrangement pitch P2 (for example, the distance between a1 and a7 or a2 and a7) of the structures 3 in ±θ directions with respect to the extension direction of the tracks. By arranging the structures 3 as such, a further increase in the filling density of the structures 3 can be achieved.

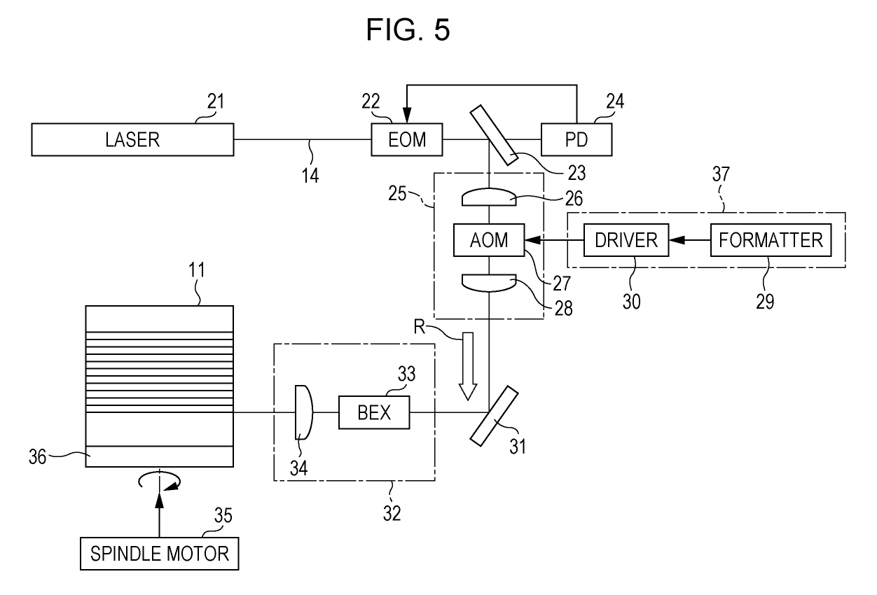

Examples of the specific shape of the structure 3 include a conical shape, a columnar shape, a needle shape, a hemispherical shape, a semi-ellipsoidal shape, and a polygonal shape. However, the shape is not limited to such shapes and may employ other shapes. Examples of the conical shape include a conical shape having a sharp apex portion, a conical shape having a flat apex portion, and a conical shape in which the apex portion has a convexly or concavely curved surface, and the conical shape is not limited to these shapes. As the conical shape in which the apex portion has a convexly curved surface, a two-dimensionally curved shape such as a paraboloid shape may be employed. In addition, a conical surface having the conical shape may be bent into a concave shape or a convex shape. In the case where a roll master copy is produced using a roll master copy exposure apparatus (see FIG. 5) described later, it is preferable that, as the shape of the structure 3, an elliptical cone shape in which the apex portion has a convexly curved surface or a truncated elliptical cone shape having a flat apex portion be employed and the major axis direction of the elliptical shape forming the bottom surface thereof be aligned with the extension direction of the track T.

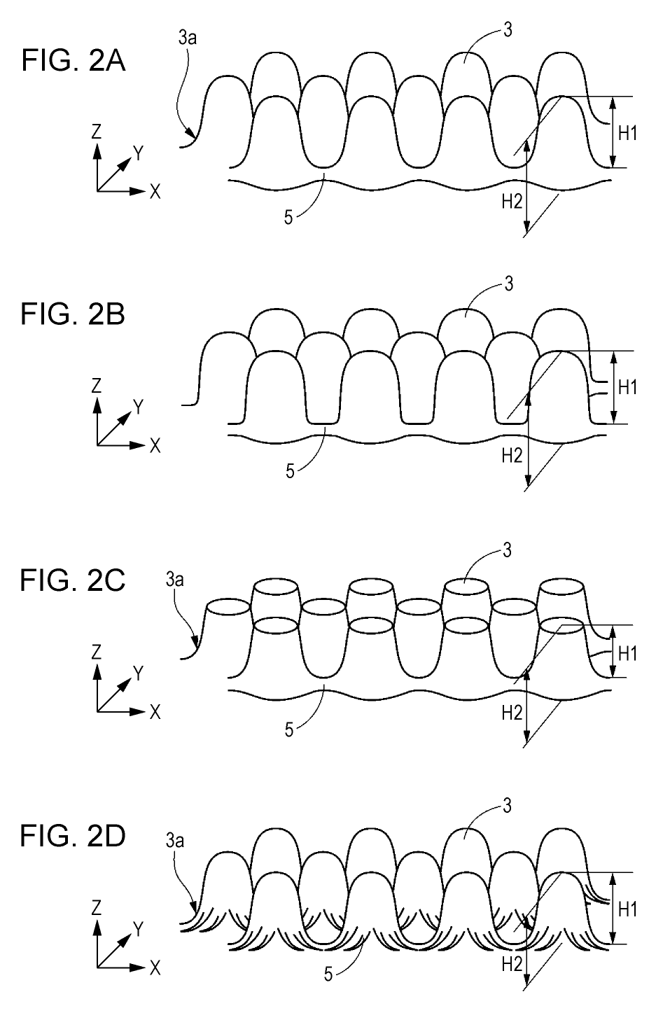

In terms of the enhancement of reflection properties, as illustrated in FIG. 2A, a conical shape in which the slope of the apex portion is gentle and the slope is gradually sharpened from the center portion toward the bottom portion is preferable. In addition, in terms of the enhancement of reflection properties and transmission properties, as illustrated in FIG. 2B, a conical shape in which the slope of the central portion is sharper than the slopes of the bottom portion and the apex portion or as illustrated in FIG. 2C, a conical shape in which the apex portion is flat is preferable. In the case where the structure 3 has the elliptical cone shape or the truncated elliptical cone shape, it is preferable that the major axis direction of the bottom surface thereof be parallel to the extension direction of the track.

As illustrated in FIGS. 2A to 2C, it is preferable that the structure 3 has a curved surface portion 3a of which the height is gradually reduced in a direction from the apex portion toward the lower portion, at the peripheral edge portion of the bottom portion. This is because the optical element 1 can be easily peeled off from a master copy or the like in the production processes of the optical element 1. In addition, the curved surface portion 3a may be provided only in a part of the peripheral portion of the structure 3. However, it is preferable that the curved surface portion 3a be provided over the entirety of the peripheral edge portion of the structure 3 in terms of the enhancement of peeling properties.

It is preferable that protrusion portions 5 be provided in a part or the entirety of the periphery of the structure 3. In this case, reflectance can be suppressed to be a low level even when the filling ratio of the structures 3 is low. In terms of ease of formation, as illustrated in FIGS. 2A to 2C, it is preferable that the protrusion portions 5 be provided between adjacent structures 3. Alternatively, as illustrated in FIG. 2D, slender protrusion portions 5 may be disposed in a part or the entirety of the periphery of the structure 3. The slender protrusion portion 5 may extend, for example, in a direction from the apex portion of the structure 3 toward the lower portion, but the slender protrusion portion 5 is not particularly limited thereto. Examples of the shape of the protrusion portion 5 include a triangular cross-section and a quadrangular cross-section. However, the shape thereof is not particularly limited to these shapes and may be selected in consideration ease of formation and the like. In addition, the surface of a part of or the entirety of the periphery of the structures 3 may be roughened so as to form fine convexities and concavenesses. Specifically, for example, the surfaces between adjacent structures 3 may be roughened so as to form fine convexities and concavenesses. Alternatively, small holes may be formed in the surfaces, for example, the apex portions, of the structures 3.

In addition, as FIGS. 1A to 2D, the individual structures 3 have the same size, shape, and height. However, the shapes of the structures 3 are not limited thereto, and structures 3 having two or more sizes, shapes, and heights may be formed on the surface of the base body.

The structures 3 are arranged regularly (periodically) and two-dimensionally with a short arrangement pitch equal to or less than the wavelength band of light, for example, for the purpose of a reduction in reflection. By arranging the plurality of structures 3 two-dimensionally as such, a two-dimensional wavefront may be formed on the surface of the base body 2. Here, the arrangement pitch refers to an arrangement pitch P1 and an arrangement pitch P2. The wavelength band of light for the purpose of a reduction in reflection is, for example, the wavelength band of ultraviolet light, the wavelength band of visible light, or the wavelength band of infrared light. Here, the wavelength band of ultraviolet light refers to a wavelength band of 10 nm to 360 nm, the wavelength band of visible light refers to a wavelength band of 360 nm to 830 nm, and the wavelength band of infrared light refers to a wavelength band of 830 nm to 1 mm. Specifically, it is preferable that the arrangement pitch be 175 nm or more, and 350 nm or less. When the arrangement pitch is less than 175 nm, production of the structures 3 tends to be difficult. On the other hand, when the arrangement pitch exceeds 350 nm, diffraction of visible light tends to occur.

It is preferable that the height H1 of the structures 3 in the extension direction of the track be smaller than the height H2 of the structures 3 in the row direction. That is, it is preferable that the heights H1 and H2 of the structures 3 satisfy the relationship of H1<H2. This is because when the structures 3 are arranged to satisfy the relationship of H1H2, it becomes necessary to increase the arrangement pitch P1 in the extension direction of the track, so that the filling ratio of the structures 3 in the extension direction of the track is reduced. When the filling ratio is reduced as such, degradation of reflection properties is caused.

The height of the structure 3 is not specifically limited and is appropriately set according to the wavelength region of light to be transmitted. For example, the height is set in a range of equal to or greater than 236 nm and equal to or less than 450 nm, and preferably, in a range of equal to or greater than 415 nm and equal to or less than 421 nm.

The aspect ratio (height H/arrangement pitch P) of the structure 3 is in a range of preferably equal to or greater than 0.6 and equal to or less than 5, more preferably equal to or greater than 0.6 and equal to or less than 4, and most preferably equal to or greater than 0.6 and equal to or less than 1.5. When the aspect ratio is less than 0.6, reflection properties and transmission properties tend to be reduced. On the other hand, when the aspect ratio exceeds 5, transferability tends to be reduced even in the case where a treatment for enhancing release properties is performed by subjecting a master copy to fluorine coating or the like, adding an additive such as a silicone-based additive or a fluorine-based additive to a transfer resin, and the like. In addition, when the aspect ratio exceeds 4, luminous reflectance is not significantly changed. Therefore, in consideration of both the enhancement of luminous reflectance and ease of release properties, it is preferable that the aspect ratio be equal to or less than 4. When the aspect ratio exceeds 1.5, in the case where the treatment for enhancing release properties as described above is not performed, transferability tends to be reduced.

Furthermore, in terms of further enhancement of reflection properties, it is preferable that the aspect ratio of the structure 3 be set to be in a range of equal to or greater than 0.94 and equal to or less than 1.46. Moreover, in terms of further enhancement of the transmission properties, it is preferable that the aspect ratio of the structure 3 be set to be in a range of equal to or greater than 0.81 and equal to or less than 1.28.

In addition, the aspect ratios of the structures 3 are not limited to a case of being the same, and the individual structures 3 may be configured to have certain height distribution (for example, the aspect ratios in a range of about 0.83 to 1.46). By providing the structures 3 having a height distribution, the wavelength dependence of reflection properties can be reduced. Consequently, the optical element 1 having excellent anti-reflection properties can be realized.

Here, the height distribution means that the structures 3 having at least two types of heights are provided on the surface of the base body 2. For example, structures 3 having a reference height and structures 3 having heights different from that of the former structures 3 may be provided on the surface of the base body 2. In this case, the structures 3 having heights different from the reference height are provided periodically or non-periodically (randomly), for example, on the surface of the base body 2. Examples of the direction of the periodicity include the extension direction of the track and the row direction.

The aspect ratio in the present disclosure is defined by Expression (1) as follows:

Aspect ratio=H/P (1)

where, H: height of structure, P: average arrangement pitch (average period).

Here, the average arrangement pitch P is defined by Expression (2) as follows.

Average arrangement pitch P═(P1+P2+P2)/3 (2)

where, P1: arrangement pitch in the extension direction of the track (period in the track extension direction), P2: arrangement pitch (period in a θ direction) in ±θ directions (here, θ=60°−δ, and δ preferably satisfies 0°<ε≦11° and more preferably satisfies 3°≦δ≦6° with respect to the extension direction of the track.

In addition, the height H of the structure 3 refers to a height of the structure 3 in the row direction. The height of the structure 3 in the track extension direction (the X direction) is smaller than the height in the row direction (Y direction), and the height of the structure 3 in parts other than the track extension direction is substantially the same as the height in the row direction, so that the height of a subwavelength structure is represented by the height in the row direction. However, in the case where the structure 3 is a concave portion, the height H of the structure in Expression (1) described above is referred to as the depth H of the structure.

It is preferable that a ratio P1/P2 satisfy a relationship of 1.00≦P1/P2≦1.1 or 1.00<P1/P2≦1.1, assuming that the arrangement pitch of the structures 3 in the same track is P1 and the arrangement pitch of the structures 3 between two adjacent tracks is P2. In such a numerical range, the filling ratio of the structures 3 having an elliptical cone shape or a truncated elliptical cone shape can be enhanced, thereby enhancing the anti-reflection properties.

The filling ratio of the structures 3 on the surface of the base body is in a range of equal to or greater than 65%, preferably equal to or greater than 73%, and more preferably equal to or greater than 86%, while the upper limit thereof is 100%. By setting the filling ratio to be in such a range, anti-reflection properties can be enhanced. In order to enhance the filling ratio, it is preferable that lower portions of adjacent structures 3 be joined or overlapped with each other, or distortion be given to the structures 3 through adjustment of the ellipticity of the bottom surface of the structure or the like.

Here, the filling ratio (average filling ratio) of the structures 3 is a value obtained as follows.

First, a photograph of the surface of the optical element 1 is taken using a scanning electron microscope (SEM) in Top View. Subsequently, a unit lattice Uc is selected at random from the taken SEM photograph, and the arrangement pitch P1 of the unit lattice Uc and the track pitch Tp are measured (see FIG. 1B). In addition, the area S of the bottom surface of the structure 3 located at the center of the unit lattice Uc is measured by image processing. Next, the filling ratio is obtained using the measured arrangement pitch P1, the track pitch Tp, and the area S of the bottom surface by Expression (3) as follows:

Filling ratio=(S(hex.)/S(unit))×100 (3)

Unit lattice area: S(unit)=P1×2Tp

Area of bottom surface of structure present in unit lattice: S (hex.)=2S

The process of calculating the filling ratio described above is performed on 10 unit lattices selected at random from the taken SEM photograph. Then, the measured values are simply averaged (arithmetic average) to obtain the average of the filling ratios, and this is assumed to be the filling ratio of the structures 3 on the surface of the base body.

Regarding a filling ratio when the structures 3 are overlapped or auxiliary structures such as protrusion portions 4 are present between the structures 3, the filling ratio can be obtained by a method of determining an area ratio using a part corresponding to 5% of the height with respect to the height of the structure 3 as a threshold value.

It is preferable that the structures 3 be connected so that the lower portions thereof are overlapped with each other. Specifically, it is preferable that the lower portions of parts or the entireties of the structures 3 in an adjacent relationship be overlapped with each other, and it is preferable that the lower portions be overlapped in the track direction, in the θ direction, or in both of these directions. By overlapping the lower portions of the structures 3 with each other as such, the filling ratio of the structures 3 can be enhanced. It is preferable that the structures be overlapped in parts which are equal to or less than ¼ the maximum value of the wavelength band of light under a usage environment on an optical path in consideration of refractive index. Accordingly, excellent anti-reflection properties can be obtained.

The ratio ((2r/P1)×100) of the diameter 2r to the arrangement pitch P1 is equal to or greater than 85%, preferably equal to or greater than 90%, and more preferably equal to or greater than 95%. This is because, in such a range, the filling ratio of the structures 3 is improved and thus anti-reflection properties can be enhanced. When the ratio ((2r/P1)×100) increases and overlapping of the structures 3 increases excessively, the anti-reflection properties tend to be degraded. Therefore, it is preferable to set the upper limit value of the ratio ((2r/P1)×100) so that the structures be overlapped in parts which are equal to or less than ¼ the maximum value of the wavelength band of light under a usage environment on an optical path in consideration of refractive index. Here, the arrangement pitch P1 is, as illustrated in FIG. 2B, an arrangement pitch of the structures 3 in the track direction and the diameter 2r is, as illustrated in FIG. 2B a diameter of the bottom surface of the structure in the track direction. In the case where the bottom surface of the structure is circular, the diameter 2r refers to a diameter, and in the case where the bottom surface of the structure is elliptical, the diameter 2r refers to a long diameter.

### Action of Optical Element

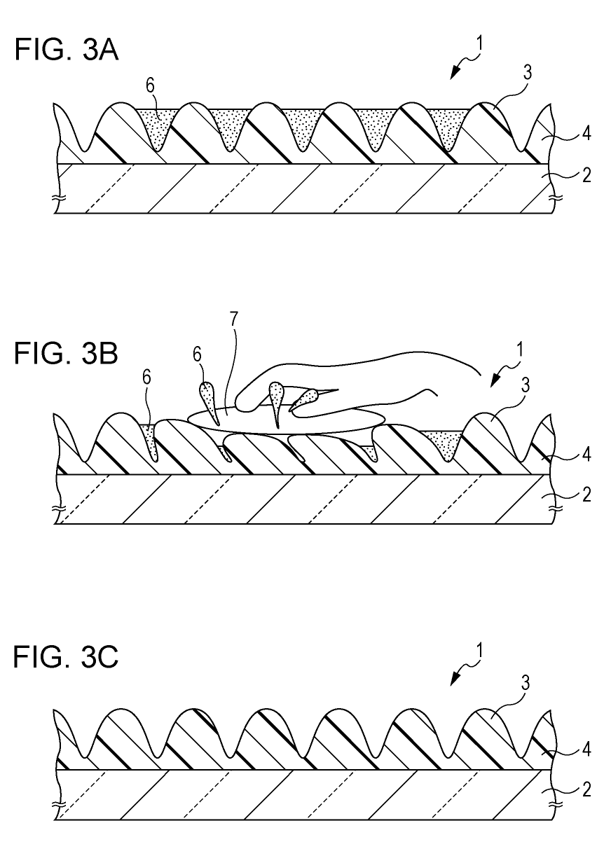

FIGS. 3A to 3C are schematic diagrams illustrating an action of the optical element according to the first embodiment of the present disclosure. As illustrated in FIG. 3A, regarding the surface of the optical element 1 touched by a finger or the like, stains 6 due to fingerprints are adhered between the structures 3. When the surface of the optical element 1 in such a state is subjected to dry cloth wiping with a fiber 7 or the like, as illustrated in FIG. 3B, since the structures 3 have sufficient elasticity, the structures 3 are deformed elastically, adjacent structures 3 come into contact with each other, such that the stains 6 adhered between the structures 3 are pushed out to the outside from the space between the structures 3. Accordingly, the stains 6 due to fingerprints are removed. Then, as shown in FIG. 3C, after the dry cloth wiping, the shapes of the structures 3 are restored to the original shape by elasticity of the structures 3 themselves.

### Configuration of Roll Master

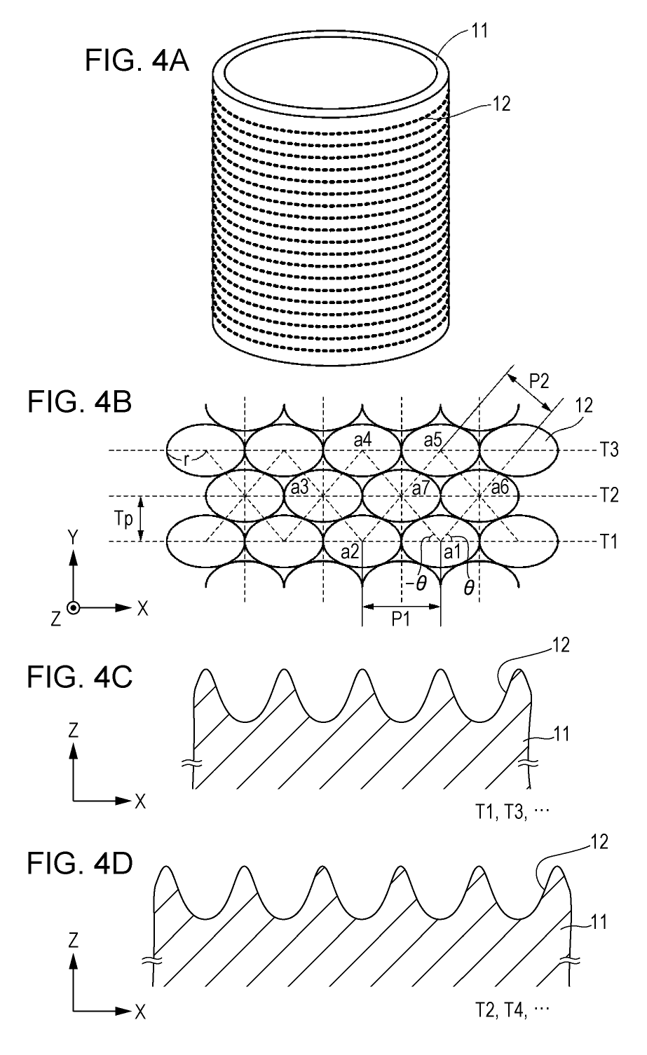

FIG. 4A is a perspective view illustrating an example of the configuration of a roll master copy. FIG. 4B is an enlarged plan view illustrating a part of the roll master copy illustrated in FIG. 4A. FIG. 4C is a cross-sectional view taken along the tracks T1, T3, . . . of FIG. 4B. FIG. 4D is a cross-sectional view taken along the tracks T2, T4, . . . of FIG. 4B. A roll master copy 11 is a master copy for forming the plurality of structures 3 on the surface of the base body described above. The roll master copy 11 has, for example, a columnar shape or a cylindrical shape, and the columnar surface or the cylindrical surface refers to a forming surface for forming the plurality of structures 3 on the surface of the base body. A plurality of structures 12 are two-dimensionally arranged on the forming surface. The structures 12 have, for example, concave shapes with respect to the forming surface. The material of the roll master copy 11 may use, for example, glass and is not particularly limited to this material.

The plurality of structures 12 arranged on the forming surface of the roll master copy 11 and the plurality of structures 3 arranged on the surface of the base body 2 described above are in an inverted concave-convex relationship. That is, the shape, arrangement, and arrangement pitch of the structures 12 of the roll master copy 11 are the same as those of the structures 3 of the base body 2.

### Configuration of Exposure Apparatus

FIG. 5 is a schematic diagram illustrating an example of the configuration of a roll master copy exposure apparatus for producing a roll master copy. The roll master copy exposure apparatus is configured to have an optical disk recording apparatus as a base.

A laser light source 21 is a light source for exposing a resist formed as a film to the surface of the master copy roll 11 serving as a recording medium and oscillating a laser light 14 for recording with a wavelength of λ=266 nm, for example. The laser light 14 emitted from the laser light source 21 rectilinearly propagates as a parallel beam and enters an electro optical modulator (EOM) 22. The laser light 14 transmitted by the electro optical modulator 22 is reflected by a mirror 23 and is led to a modulation optical system 25.

The mirror 23 is configured of a polarizing beam splitter, and has a function of reflecting one polarization component and transmitting the other polarization component. The polarization component transmitted by the mirror 23 is sensed by a photodiode 24, and the electro optical modulator 22 is controlled on the basis of the sensed light signal, so that phase modulation of the laser light 14 is performed.

In the modulation optical system 25, the laser light 14 is condensed on an acousto-optic modulator (AOM) 27 made of glass (SiO₂) or the like by a condenser lens 26. The laser light 14 is subjected to intensity modulation by the acousto-optic modulator 27, so as to diverge and is subsequently converted into a parallel beam with a lens 28. The laser light 14 emitted from the modulation optical system 25 is reflected by a mirror 31 and is led onto a moving optical table 32 horizontally and in parallel.

The moving optical table 32 includes a beam expander 33 and an objective lens 34. The laser light 14 led to the moving optical table 32 is shaped into a desired beam shape by the beam expander 33 and is subsequently caused to illuminate the resist layer on the roll master copy 11 via the objective lens 34. The roll master copy 11 is placed on a turntable 36 connected to a spindle motor 35. Then, while the roll master copy 11 is rotated, the laser light 14 is moved in the height direction of the roll master copy 11, and the laser light 14 is caused to intermittently illuminate the resist layer, thereby performing an exposure process of the resist layer. A formed latent image has a substantially elliptical shape having a major axis in the circumferential direction. The movement of the laser light 14 is performed by movement of the moving optical table 32 in the arrow R direction.

The exposure apparatus includes a control mechanism 37 for forming a latent image corresponding to the two-dimensional pattern of the hexagonal lattice or the quasi-hexagonal lattice illustrated in FIG. 1B on the resist layer. The control mechanism 37 includes a formatter 29 and a driver 30. The formatter 29 includes a polarity reversing portion, and the polarity reversing portion controls an illumination timing of the laser light 14 for the resist layer. The driver 30 receives an output from the polarity reversing portion and controls the acousto-optic modulator 27.

In this roll master copy exposure apparatus, a polarity reversal formatter signal and a rotation controller are synchronized to generate a signal and intensity modulation is performed by the acousto-optic modulator 27 for each track so that the two-dimensional patterns are linked spatially. The hexagonal lattice or quasi-hexagonal lattice pattern can be recorded by performing patterning at a constant angular velocity (CAV) and an appropriate number of revolutions with an appropriate modulation frequency and an appropriate feed pitch.

### Production Method of Optical Element

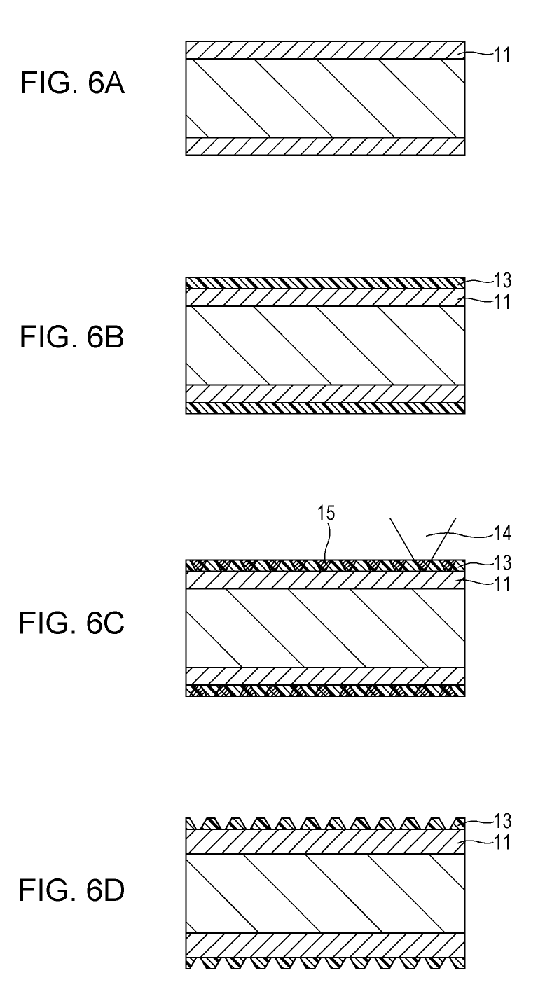

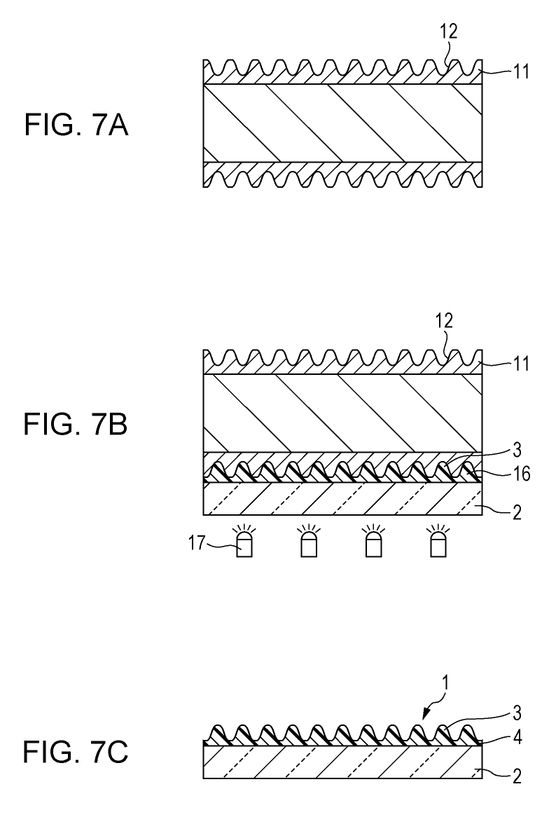

Next, a production method of the optical element 1 according to the first embodiment of the present disclosure will be described with reference to FIGS. 6A to 7C.

### Resist Film Formation Process

First, as illustrated in FIG. 6A, a roll master copy 11 having a columnar shape or a cylindrical shape is prepared. This roll master copy 11 is, for example, a glass master copy. Subsequently, as illustrated in FIG. 6B, a resist layer 13 is formed on the surface of the glass roll master copy 11. As the material of the resist layer 13, for example, any of an organic resist and an inorganic resist may be used. As the organic resist, for example, a novolac resist and a chemically amplified resist may be used. As the inorganic resist, for example, a metallic compound containing one or more kinds may be used.

### Exposure Step

Next, as illustrated in FIG. 6C, the resist layer 13 formed on the surface of the roll master copy 11 is illuminated with a laser light (exposure beam) 14. Specifically, the resist layer 13 is placed on the turntable 36 of the roll master copy exposure apparatus shown in FIG. 5, the roll master copy 11 is rotated, and then the resist layer 13 is illuminated with the laser light (exposure beam) 14. At this time, the laser light 14 is emitted intermittently while the laser light 14 is moved in the height direction of the roll master copy 11 (a direction parallel to the center axis of the roll master copy 11 having a columnar shape or a cylindrical shape), thereby exposing the resist layer 13 over the entire surface. Accordingly, a latent image 15 according to the locus of the laser light 14 is formed over the entire surface of the resist layer 13 with, for example, the same level of pitch as the wavelength of visible light.

For example, the latent image 15 is arranged to constitute a plurality of rows of tracks on the roll master copy surface and form a hexagonal lattice pattern or a quasi-hexagonal lattice pattern. For example, the latent image 15 has an elliptical shape with a major axis direction in the extension direction of the track.

### Developing Process

Next, for example, a developing liquid is dropped onto the resist layer 13 while the roll master copy 11 is rotated, such that the resist layer 13 is subjected to a developing treatment. Accordingly, as illustrated in FIG. 6D, s plurality of opening portions are formed on the resist layer 13. In the case where the resist layer 13 is formed from a positive type resist, exposure portions exposed by the laser light 14 have an increased dissolution rate with respect to the developing liquid compared to that of the non-exposure portions. Therefore, as shown in FIG. 6D, a pattern corresponding to the latent image (the exposure portions) 16 is formed on the resist layer 13. The pattern of the opening portions is a predetermined lattice pattern such as a hexagonal lattice pattern or a quasi-hexagonal lattice pattern.

### Etching Process

Next, the surface of the roll master copy 11 is subjected to an etching treatment using the pattern (resist pattern) of the resist layer 13 formed on the roll master copy 11 as a mask. Accordingly, as illustrated in FIG. 7A, concave portions having elliptical cone shape or a truncated elliptical cone shape with a major axis direction in the extension direction of the track, that is, structures 12, can be obtained. As the etching method, for example, dry etching or wet etching may be performed. At this time, for example, a pattern of the structures 12 having a conical shape can be formed by alternately performing the etching treatment and an asking treatment.

In this manner, a desired roll master copy 11 is obtained.

### Transfer Process

Next, as illustrated in FIG. 7B, after the roll master copy 11 and a transfer material 16 applied onto the base body 2 are caused to come into close contact with each other, the transfer material 16 is illuminated with energy rays such as UV light from an energy ray source 17 to cure the transfer material 16, and then the base body 2 formed integrally with the cured transfer material 16 is peeled off. Accordingly, as shown in FIG. 7C, the optical element 1 having the plurality of structures 3 on the surface of the base body is produced.

The energy ray source 17 may be any one that emits energy rays, such as, electron rays, ultraviolet rays, infrared rays, laser beams, visible rays, ionizing radiation (X-rays, α-rays, β-rays, γ-rays, and the like), microwaves, or high-frequency wave, and is not particularly limited.

It is preferable that an energy ray-curable resin composition be used as the transfer material 16. It is preferable that a UV-curable resin composition be used as the energy ray-curable resin composition. The energy ray-curable resin composition may contain fillers, functional additives, and the like, if necessary.

It is preferable that the energy ray-curable resin composition contain silicone acrylate, urethane acrylate, and initiators. As the silicone acrylate, one having two or more acrylate-based polymerizable unsaturated groups at a side chain, an end, or both in a molecule may be used. As the acrylate-based polymerizable unsaturated group, one or more of a (meth)acryloyl group and a (meth)acryloyloxy group may be used. Here, the (meth)acryloyl group is used as the meaning of an acryloyl group or a methacryloyl group.

Examples of the silicone acrylate and the methacrylate include polydimethylsiloxane having an organically modified acrylic group. Organic modification may be polyether modification, polyester modification, aralkyl modification, polyether/polyester modification. Specific examples thereof include SILAPLANE FM7725 produced by Chisso Corporation, EB350 and EB1360 produced by DAICEL-CYTEC Company, Ltd., and EGORad 2100, TEGORad 2200 N, TEGORad 2250, TEGORad 2300, TEGORad 2500, and TEGORad 2700 produced by Degussa Japan Co., Ltd.

As the urethane acrylate, one having two or more acrylate-based polymerizable unsaturated groups at a side chain, an end, or both in a molecule may be used. As the acrylate-based polymerizable unsaturated group, one or more of a (meth)acryloyl group and a (meth)acryloyloxy group may be used. Here, the (meth)acryloyl group is used as the meaning of an acryloyl group or a methacryloyl group.

Examples of the urethane acrylate include urethane acrylate, urethane methacrylate, aliphatic urethane acrylate, aliphatic urethane methacrylate, aromatic urethane acrylate, and aromatic urethane methacrylate, such as, functional urethane acrylate oligomer CN series CN980, CN965, CN962, and the like produced by Sartomer Company, Inc.

Examples of the initiators include 2,2-dimethoxy-1,2-diphenylethan-1-one, 1-hydroxy-cyclohexylphenylketone, and 2-hydroxy-2-methyl-1-phenylpropan-1-one.

As the filler, for example, any of inorganic fine particles and organic fine particles may be used. Examples of the inorganic fine particles include metal oxide fine particles such as SiO₂, TiO₂, ZrO₂, SnO₂, and Al₂O₃.

Examples of the functional additives include a leveling agent, a surface adjusting agent, and an anti-foaming agent. Examples of the material of the base body 2 include a methyl methacrylate (co)polymer, polycarbonate, a styrene (co)polymer, a methyl methacrylate-styrene copolymer, cellulose diacetate, cellulose triacetate, cellulose acetate butyrate, polyester, polyamide, polyimide, polyether sulfone, polysulfone, polypropylene, polymethylpentene, polyvinyl chloride, polyvinyl acetal, polyether ketone, polyurethane, and glass.

The method of forming the base body 2 is not particularly limited, and injection-molded body, an extruded body, or a casted body may be used. If necessary, the surface of the base body may be subjected to a surface treatment such as a corona treatment.

In the case where a structure 3 having a high aspect ratio (for example, a structure 3 having an aspect ratio of more than 1.5 and equal to or less than 5) is produced, in order to improve release properties of the master copy such as the roll master 11, it is preferable to apply a release agent such as a silicone-based release agent or a fluorine-based mold release agent to the surface of the master copy such as the roll master 11. Moreover, it is preferable to add an additive such as a fluorine-based additive or a silicone-based additive to the transfer material 16.

According to the first embodiment, since the elastic modulus of the structure 3 is equal to or greater than 1 MPa and equal to or less than 1200 MPa, degradation of reflection properties due to adhesion of adjacent structures can be suppressed, and stains infiltrating between the structures can be pushed out and wiped off. In addition, since the aspect ratio of the structure 3 is equal to or greater than 0.6 and equal to or less than 5, degradation of reflection properties and transmission properties can be suppressed, and degradation of the transferability of the structure 3 can be suppressed. In addition, since the coefficient of kinetic friction of the surface of the optical element provided with the plurality of structures 3 is equal to or less than 0.85, degradation of reflection properties due to adhesion of adjacent structures can be suppressed.

### 2. Second Embodiment

### Configuration of Optical Element

FIG. 8A is a plan view illustrating an example of the configuration of an optical element according to a second embodiment of the present disclosure. FIG. 8B is an enlarged plan view illustrating a part of the optical element illustrated in FIG. 8A. FIG. 8C is a cross-sectional view taken along the tracks T1, T3, . . . of FIG. 8B.

FIG. 8D is a cross-sectional view taken along the tracks T2, T4, . . . of FIG. 8B.

An optical element 1 according to the second embodiment is different from that of the first embodiment in that the plurality of structures 3 in three adjacent rows of tracks T constitute a tetragonal lattice pattern or a quasi-tetragonal lattice pattern.

Here, the tetragonal lattice refers to a square lattice. The quasi-tetragonal lattice refers to a lattice having a distorted square shape, unlike the square lattice. For example, in the case where the structures 3 are arranged on a straight line, the quasi-tetragonal lattice refers to a tetragonal lattice obtained by stretching a square lattice in the arrangement direction with the straight line shape (track direction) so as to be distorted. In the case where the structures 3 are arranged meanderingly, the quasi-tetragonal lattice refers to a tetragonal lattice obtained by distorting a lattice having a square shape according to the meandering arrangement of the structures 3. Alternatively, the quasi-tetragonal lattice refers to a tetragonal lattice obtained by stretching a lattice having a square shape in the arrangement direction of the straight line shape (track direction) so as to be distorted and then distorting the lattice according to the meandering arrangement of the structures 3.

It is preferable that the arrangement pitch P1 of the structures 3 in the same track be longer than the arrangement pitch P2 of the structures 3 between two adjacent tracks. In addition, it is preferable that P1/P2 satisfy the relationship of 1.4<P1/P2≦1.5, assuming that the arrangement pitch of the structures 3 in the same track is P1 and the arrangement pitch of the structures 3 between two adjacent tracks is P2. In such a numerical range, the filling ratio of the structures 3 having an elliptical cone shape or a truncated elliptical cone shape can be enhanced, thereby enhancing the anti-reflection properties. In addition, it is preferable that the height or the depth of the structures 3 in a direction at 45 degrees or in a direction at about 45 degrees with respect to the track be smaller than the height or the depth of the structures 3 in the extension direction of the track.

It is preferable that the height H2 in the arrangement direction of the structures 3 (θ direction) inclined with respect to the extension direction of the track be smaller than the height H1 of the structures 3 in the extension direction of the track. That is, it is preferable that the heights H1 and H2 of the structures 3 satisfy the relationship of H1>H2.

It is preferable that the ellipticity e of the bottom surface of the structure be 150%≦e≦180% in the case where the structures 3 constitute the tetragonal lattice or the quasi-tetragonal lattice pattern. This is because, in this range, the filling ratio of the structures 3 is enhanced and excellent anti-reflection properties can be obtained.

The filling ratio of the structures 3 on the surface of the base body is in a range of equal to or greater than 65%, preferably equal to or greater than 73%, and more preferably equal to or greater than 86%, while the upper limit thereof is 100%. By setting the filling ratio to be in such a range, anti-reflection properties can be enhanced.

Here, the filling ratio (average filling ratio) of the structures 3 is a value obtained as follows.

First, a photograph of the surface of the optical element 1 is taken using a scanning electron microscope (SEM) in Top View. Subsequently, a unit lattice Uc is selected at random from the taken SEM photograph, and the arrangement pitch P1 of the unit lattice Uc and the track pitch Tp are measured (see FIG. 8B). In addition, the area S of the bottom surface of any of four structures 3 included in the unit lattice Uc is measured by image processing. Next, the filling ratio is obtained using the measured arrangement pitch P1, the track pitch Tp, and the area S of the bottom surface by Expression (4) as follows:

Filling ratio=(S(tetra)/S(unit))×100 (4)

Unit lattice area: S(unit)=2×((P1×Tp)ₓ(1/2))=P1×Tp

Area of bottom surface of structure present in unit lattice: S(tetra)=S

The process of calculating the filling ratio described above is performed on 10 unit lattices selected at random from the taken SEM photograph. Then, the measured values are simply averaged (arithmetic average) to obtain the average of the filling ratios, and this is assumed to be the filling ratio of the structures 3 on the surface of the base body.

The ratio ((2r/P1)×100) of the diameter 2r to the arrangement pitch P1 is equal to or greater than 64%, preferably equal to or greater than 69%, and more preferably equal to or greater than 73%. This is because, in such a range, the filling ratio of the structures 3 is improved and thus anti-reflection properties can be enhanced. Here, the arrangement pitch P1 is an arrangement pitch of the structures 3 in the track direction, and the diameter 2r is a diameter of the bottom surface of the structure in the track direction. In the case where the bottom surface of the structure is circular, the diameter 2r refers to a diameter, and in the case where the bottom surface of the structure is elliptical, the diameter 2r refers to a long diameter.

According to the second embodiment, the same effects as those of the first embodiment can be obtained.

### 3. Third Embodiment

FIG. 9A is a plan view illustrating an example of the configuration of an optical element according to a third embodiment of the present disclosure. FIG. 9B is an enlarged plan view illustrating a part of the optical element illustrated in FIG. 9A. FIG. 9C is a cross-sectional view taken along the line IXC-IXC illustrated in FIG. 9B.

An optical element 1 according to the third embodiment is different from that of the first embodiment in that the plurality of structures 3 are randomly (irregularly) and two-dimensionally arranged. Furthermore, at least one of the shape, size, and height of structures 21 may be randomly changed.

The third embodiment is the same as the first embodiment except for the above-described configuration.

The master copy for producing the optical element 1 may use, for example, a method of anodizing the surface of an aluminum base material and is not limited to this method.

In the third embodiment, the plurality of structures 3 are randomly and two-dimensionally arranged, an occurrence of unevenness in the outer appearance can be suppressed.

### 4. Fourth Embodiment

FIG. 10A is a plan view illustrating an example of the configuration of an optical element according to a fourth embodiment of the present disclosure. FIG. 10B is an enlarged plan view illustrating a part of the optical element illustrated in FIG. 10A. FIG. 10C is a cross-sectional view taken along the tracks T1, T3, . . . of FIG. 10B. FIG. 10D is a cross-sectional view taken along the tracks T2, T4, . . . of FIG. 10B.

An optical element 1 according to the fourth embodiment is different from that of the first embodiment in that a large number of structures 3 which are concave portions are arranged on the surface of the base body. The shape of this structure 3 is a concave shape formed by inverting the convex shape of the structure 3 in the first embodiment. In the case where the structure 3 is formed as a concave portion as described above, the opening portion (the inlet portion of the concave portion) of the structure 3 having a concave shape is defined as a lower portion and the lowermost portion (the deepest portion of the concave portion) of the base body 2 in the depth direction is defined as an apex portion. That is, the apex portion and the lower portion are defined on the basis of the structure 3 which is an unrealistic space. In addition, in the fourth embodiment, since the structure 3 has the concave shape, the height H of the structure 3 in Expression (1) and the like is the depth H of the structure 3.

In the fourth embodiment, configurations other than the above-described configuration are the same as those of the first embodiment.

In the fourth embodiment, since the shape of the structure 3 having a convex shape in the first embodiment is inverted into a concave shape, the same effects as those in the first embodiment can be obtained.

### 5. Fifth Embodiment

An optical element 1 according to a fifth embodiment is different from the optical element 1 of the first embodiment in that both a base body 2 and structure 3 have flexibility. The elastic modulus of the material forming the structure 3 is equal to or greater than 1 MPa and equal to or less than 1200 MPa as described in the first embodiment.

The elongation rate of the material forming the structures 3 is in a range of preferably equal to or greater than 50%, and more preferably equal to or greater than 50% and equal to or less than 150%. When the elongation rate is equal to or greater than 50%, breakage of the structures 3 due to deformation of a resin along with a close contact or a contact does not occur and thus a change in reflectance before and after wiping can be suppressed. As the elongation rate of the material forming the structures 3 is increased, sliding properties during wiping are degraded, and thus wiping performance tends to be degraded. When the elongation rate is equal to or less than 150%, degradation of the sliding properties of the surface is easily suppressed.

The elongation rate of the material forming the base body 2 is in a range of preferably equal to or greater than 20%, and more preferably equal to or greater than 20% and equal to or less than 800%. When the elongation rate is equal to or greater than 20%, plastic deformation can be suppressed. When the elongation rate is equal to or less than 800%, the material can be selected relatively easily. For example, in the case of a urethane film, it becomes possible to select a non-yellowing grade.

FIG. 11A is a cross-sectional view illustrating a first example of the optical element 1 according to the fifth embodiment. The optical element 1 includes structures 3 and a base body 2 formed individually, and an interface is formed therebetween. Therefore, the materials forming the base body 2 and the structures 3 can be different materials, if necessary. That is, the base body 2 and the structures 3 can have different elastic moduli from each other.

The elastic modulus of the material forming the base body 2 is in a range of preferably equal to or greater than 1 MPa and equal to or less than 3000 MPa, more preferably equal to or greater than 1 MPa and equal to or less than 1500 MPa, and even more preferably equal to or greater than 1 MPa and equal to or less than 1200 MPa. When the elastic modulus is less than 1 MPa, in general, a resin with a low elastic modulus may have significant surface stickiness and thus is difficult to be handled. On the other hand, when the elastic modulus is equal to or less than 3000 MPa, an occurrence of plastic deformation is suppressed and visual recognition thereof is almost eliminated. In addition, it is preferable that the elongation rates of the materials forming the base body 2 and the structures 3 be caused to be equal or substantially equal to each other. This is because peeling at the interface between the base body 2 and the structures 3 can be suppressed. Here, the fact that the elongation rates are substantially equal to each other means that a difference in elastic modulus between the materials forming the base body 2 and the structures 3 is in a range of ±25%. Here, the elastic moduli of the base body 2 and the structures 3 are not necessarily equal to each other, and may be set to be different from each other in the above-described numerical range.

In the case where the elastic modulus of the material forming the base body 2 is in a range of equal to or greater than 1 MPa and equal to or less than 3000 MPa, the thickness D of the base body 2 is in a range of preferably equal to or greater than 60 μm and more preferably equal to or greater than 60 μm and equal to or less than 2000 μm. When the thickness is equal to or greater than 60 μm, an occurrence of plastic deformation and cohesive failure is suppressed and visual recognition thereof is almost eliminated. On the other hand, when the thickness is equal to or less than 2000 μm, continuous transfer can be performed by roll-to-roll processing.

FIG. 11B is a cross-sectional view illustrating a second example of the optical element according to the fifth embodiment. The optical element 1 includes a plurality of structures 3, a basal layer 4 formed adjacent to the structures 3, and a base body 2 formed adjacent to the basal layer 4. The basal layer 4 is, for example, a layer formed integrally with the structures 3 on the bottom surface side of the structures 3, and an interface is formed between the basal layer 4 and the base body 2. It is preferable to use a material having stretchability and elasticity as the material of the base body 2, examples of the material include polyurethane, a transparent silicone resin, and polyvinyl chloride. The material of the base body 2 is not particularly limited to a transparent material and may use a color material in black or the like. Examples of the shape of the base body 2 include a sheet shape, a plate shape, and a block shape, and the shape thereof is not particularly limited to these shapes. Here, it is defined that the sheet includes a film.

The elastic modulus of the material forming the basal layer 4 is in a range of preferably equal to or greater than 1 MPa and equal to or less than 3000 MPa, more preferably equal to or greater than 1 MPa and equal to or less than 1500 MPa, and even more preferably equal to or greater than 1 MPa and equal to or less than 1200 MPa. In the case where the structures 3 and the basal layer 4 are transferred at the same time, when the elastic modulus is less than 1 MPa, adjacent structures are adhered to each other in a transfer process, and the shape of the structures 3 becomes a shape different from a desired shape, so that desired reflection properties are not obtained. In addition, sliding properties during wiping are degraded, and thus wiping performance tends to be degraded. On the other hand, when the elastic modulus is equal to or less than 3000 MPa, an occurrence of plastic deformation is suppressed and visual recognition thereof is almost eliminated.

In the case where the elastic modulus of the material forming the base body 2 and the basal layer 4 is in a range of equal to or greater than 1 MPa and equal to or less than 3000 MPa, the total thickness of the base body 2 and the basal layer 4 is in a range of preferably equal to or greater than 60 μm and more preferably equal to or greater than 60 μm and equal to or less than 2000 μm. When the thickness is equal to or greater than 60 μm, an occurrence of plastic deformation and cohesive failure is suppressed and visual recognition thereof is almost eliminated. On the other hand, when the thickness is equal to or less than 2000 μm, continuous transfer can be performed by roll-to-roll processing. Here, the elastic moduli of the structures 3, the base body 2, and the basal layer 4 are not necessarily equal to each other, and may be set to be different from each other in the above-described numerical range.

In the case where the elastic modulus of the material forming the basal layer 4 is in a range of equal to or greater than 1 MPa and equal to or less than 3000 MPa whereas the elastic modulus of the material forming the base body 2 is out of the range of equal to or greater than 1 MPa and equal to or less than 3000 MPa, the thickness d of the basal layer 4 is in a range of preferably equal to or greater than 60 μm and more preferably equal to or greater than 60 μm and equal to or less than 2000 μm. When the thickness is equal to or greater than 60 μm, without depending on the material and the elastic modulus of the base body 2, an occurrence of plastic deformation and cohesive failure is suppressed and visual recognition thereof is almost eliminated. On the other hand, when the thickness is equal to or less than 2000 μm, a UV-curable resin can be cured efficiently.

FIG. 11C is a cross-sectional view illustrating a third example of the optical element 1 according to the fifth embodiment. The optical element 1 includes the structures 3 and the base body 2 formed integrally with each other. Since the structures 3 and the base body 2 are formed integrally with each other as described above, no interface is present between the two.

The elastic modulus of the material forming the base body 2 is in a range of preferably equal to or greater than 1 MPa and equal to or less than 3000 MPa, more preferably equal to or greater than 1 MPa and equal to or less than 1500 MPa, and even more preferably equal to or greater than 1 MPa and equal to or less than 1200 MPa. In the case where the structures 3 and the base body 2 are transferred at the same time, when the elastic modulus is less than 1 MPa, adjacent structures are adhered to each other in a transfer process, and the shape of the structures 3 becomes a shape different from a desired shape, so that desired reflection properties are not obtained. In addition, sliding properties during wiping are degraded, and thus wiping performance tends to be degraded. On the other hand, when the elastic modulus is less than 3000 MPa, an occurrence of plastic deformation is suppressed and visual recognition thereof is almost eliminated.

In the case where the structures 3 and the base body 2 are formed integrally with each other, in terms of facilitating production, it is preferable that the elastic moduli of the materials of the two have the same value specifically in a range of equal to or greater than 1 MPa and equal to or less than 1200 MPa. It is also possible to form the structures 3 and the base body 2 integrally with each other while the elastic moduli of the two have different values. Examples of a method of forming the above-described optical element 1 include the following method. That is, multilayer application of resins having different elastic moduli is performed. Here, it is preferable that the resins have a high viscosity, and specifically, 50,000 mPa·s or more is preferable. This is because gradation of the Young's modulus can be obtained while mixing of the resins is at a low level.

In the case where the elastic modulus of the material forming the base body 2 is in a range of equal to or greater than 1 MPa and equal to or less than 3000 MPa, the thickness D of the base body 2 is in a range of preferably equal to or greater than 60 μm and more preferably equal to or greater than 60 μm and equal to or less than 2000 μm. When the thickness is equal to or greater than 60 μm, an occurrence of plastic deformation and cohesive failure is suppressed and visual recognition thereof is almost eliminated. On the other hand, when the thickness is equal to or less than 2000 μm, a UV-curable resin can be cured efficiently.

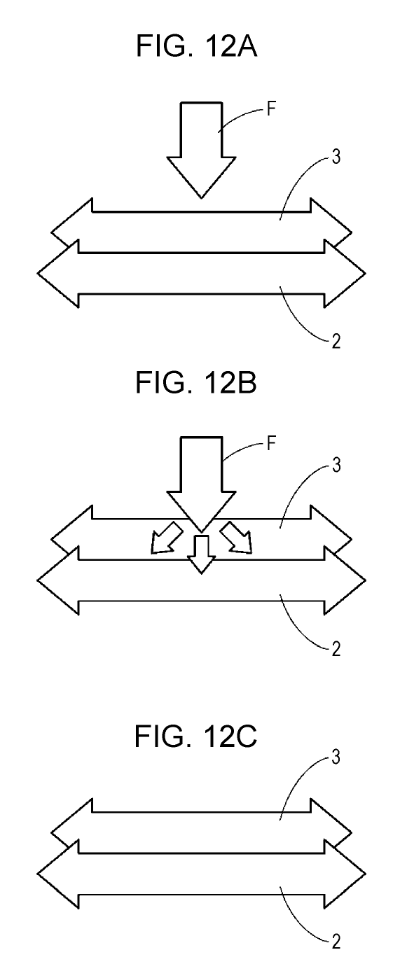

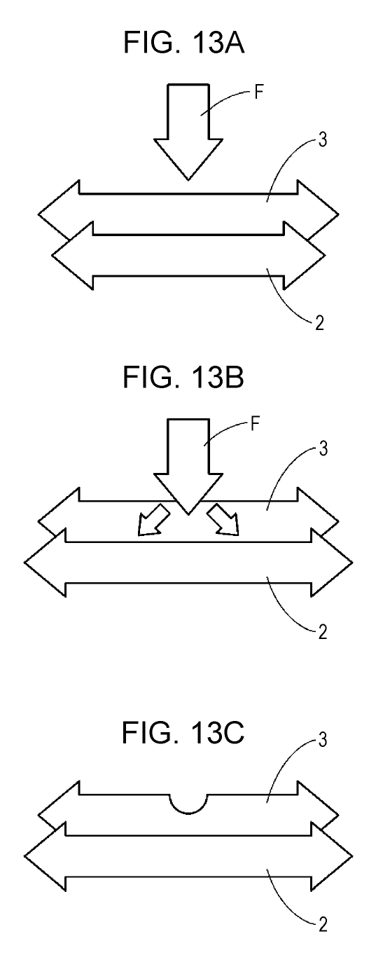

FIG. 12A to FIG. 13C are schematic diagrams illustrating differences in action between a flexible optical element and a non-flexible optical element in terms of plastic deformation. Here, the flexible optical element refers to an optical element in which both the structures 3 and the base body 2 have the flexibility. The non-flexible optical element refers to an optical element in which the structures 3 have the flexibility while the base body 2 has no flexibility.

As illustrated in FIG. 12A, when a force F is exerted on the surface of the flexible optical element, since the base body 2 has flexibility, the force F exerted on the surface of the flexible optical element is distributed as illustrated in FIG. 12B. Consequently, as illustrated in FIG. 12C, when the force F is released, the surface of the flexible optical element returns to the original flat state.

On the other hand, as illustrated in FIG. 13A, when a force F is exerted on the surface of the non-flexible optical element, since the base body 2 is hard, the force F exerted on the surface of the non-flexible optical element is not distributed, as illustrated in FIG. 13B. Consequently, as illustrated in FIG. 13C, when the force F is released, plastic deformation or cohesive peeling occurs on the surface of the non-flexible optical element.

### 6. Sixth Embodiment

FIG. 14A is a plan view illustrating an example of the configuration of an optical element according to a sixth embodiment of the present disclosure. FIG. 14B is a cross-sectional view illustrating the example of the configuration of the optical element according to the sixth embodiment of the present disclosure. As illustrated in FIGS. 14A and 14B, this optical element 1 is different from that of the first embodiment in that the base body 2 is not provided. The optical element 1 includes a plurality of structures 3 formed of a large number of convex portions arranged with fine pitches equal to or less than the wavelength of visible light, and the lower portions of the adjacent structures 3 are connected. The plurality of structures 3 of which the lower portions are connected may have mesh shape as an overall shape.

According to the sixth embodiment, since the optical element 1 does not include the base body 2, excellent flexibility can be realized. Therefore, the optical element 1 can be adhered to a three-dimensionally curved surface. In addition, the optical element 1 can be adhered to an adherend without an adhesive.

### 7. Seventh Embodiment

### Configuration of Liquid Crystal Display Apparatus

FIG. 15 is a cross-sectional view illustrating an example of the configuration of a liquid crystal display apparatus according to a seventh embodiment of the present disclosure. As illustrated in FIG. 15, this liquid crystal display apparatus includes a backlight 103 that emits light and a liquid crystal display element 101 that temporally and spatially modulates the light emitted from the backlight 103 to display an image. Polarizers 101a and 101b which are optical components are respectively provided on both surfaces of the liquid crystal display element 101. An optical element 1 is provided on the polarizer 101b provided on the display surface side of the liquid crystal display element 101. Here, the polarizer 101b provided with the optical element 1 is referred to as a polarizer 102 with an anti-reflection function. This polarizer 102 with an anti-reflection function is an example of optical components with an anti-reflection function.

The backlight 103, the liquid crystal display element 101, the polarizers 101a and 101b, and the optical element 1, which constitute the liquid crystal display apparatus, will now be described sequentially.

### Backlight

As the backlight 103, for example, a direct type backlight, an edge type backlight, and a plane light source type backlight may be used. The backlight 103 includes, for example, a light source, a reflective plate, and an optical film. As the light source, for example, a cold cathode fluorescent lamp (CCFL), a hot cathode fluorescent lamp (HCFL), organic electroluminescence (OEL), inorganic electroluminescence (IEL), and a light-emitting diode (LED) are used.

### Liquid Crystal Display Element

As the liquid crystal display element 101, those having a display mode of, for example, a twisted nematic (TN) mode, a super twisted nematic (STN) mode, a vertically aligned (VA) mode, an in-plane switching (IPS) mode, an optically compensated birefringence (OCB) mode, a ferroelectric liquid crystal (FLC) mode, a polymer dispersed liquid crystal (PDLC) mode, and a phase change guest host (PCGH) mode may be used.

### Polarizer

On both surfaces of the liquid crystal display element 101, for example, the polarizers 101a and 101b are provided so that transmission axes thereof are orthogonal to each other. The polarizers 101a and 101b transmit only one of orthogonal polarization components in the incident light and interrupt the other through absorption. As the polarizers 101a and 101b, for example, those produced by adsorbing dichroic materials such as iodine or dichroic dyes to hydrophilic polymer films such as a polyvinyl alcohol-based film, a partially formalized polyvinyl alcohol-based film, or an ethylene-vinyl acetate copolymer-based partially saponified film, and performing uniaxial stretching thereon may be used. It is preferable that protective layers such as triacetyl cellulose (TAC) films be provided on both surfaces of the polarizers 101a and 101b. In the case where the protective layers are provided, as described above, it is preferable that a configuration in which the base body 2 of the optical element 1 also functions as a protective layer be employed. This is because the thickness of a polarizer 102 with an anti-reflection function can be reduced by employing such a configuration.

### Optical Element

As the optical element 1, for example, one of the optical elements according to the first to sixth embodiments described above may be used.

According to an eighth embodiment, since the optical element 1 is provided on the display surface of the liquid crystal display apparatus, the anti-reflection function of the display surface of the liquid crystal display apparatus can be improved. Therefore, the visibility of the liquid crystal display apparatus can be improved.

### 8. Eighth Embodiment

FIG. 16 illustrates an example of the configuration of a liquid crystal display apparatus according to the eighth embodiment of the present disclosure. This liquid crystal display apparatus is different from that of the seventh embodiment in that a front member 104 is provided on the front surface side of a liquid crystal display element 101, and an optical element 1 is provided on at least one surface of the front surface of the liquid crystal display element 101 and the front rear surfaces of the front surface member 104. In FIG. 16, an example in which optical elements 1 are provided on all of the front surface of the liquid crystal display element 101 and the front and rear surfaces of the front surface member 104 is shown. For example, an air layer is formed between the liquid crystal display element 101 and the front surface member 104. Like elements which are the same as those of the seventh embodiment described above are denoted by like reference numerals, and description thereof will be omitted. Here, the front surface refers to a surface on the side serving as a display surface, that is, a surface on the observer side, and the rear surface refers to a surface on the side opposite to the display surface.

The front surface member 104 is a front panel or the like used on the front surface side (observer side) of the liquid crystal display element 101 for the purpose of mechanical, thermal, and weather-resistant protection and design. The front surface member 104 has, for example, a sheet shape, a film shape, or a plate shape. As the material of the front surface member 104, for example, glass, triacetyl cellulose (TAC), polyester (TPEE), polyethylene terephthalate (PET), polyimide (PI), polyamide (PA), aramid, polyethylene (PE), polyacrylate, polyether sulfone, polysulfone, polypropylene (PP), diacetyl cellulose, polyvinyl chloride, an acrylic resin (PMMA), and polycarbonate (PC) may be used. The material is not particularly limited to these materials, and any material having transparency may be used.

According to the ninth embodiment, like the eighth embodiment, the visibility of the liquid crystal display apparatus can be enhanced.

### 9. Ninth Embodiment

FIG. 17A is an exploded perspective view illustrating an example of the configuration of a display apparatus including an information input apparatus according to a ninth embodiment of the present disclosure. FIG. 17B is a cross-sectional view illustrating an example of the configuration of the information input apparatus according to the ninth embodiment of the present disclosure. As illustrated in FIGS. 17A and 17B, an information input apparatus 201 is provided on a display apparatus 202, and the information input apparatus 201 and the display apparatus 202 are bonded by, for example, a bonding layer 212.

The information input apparatus 201 is a so-called touch panel, and includes an information input element 211 having an information input surface for inputting information using a finger or the like and the optical element 1 provided on the information input surface. The information input apparatus 201 and the optical element 1 are bonded via, for example, a bonding layer 213. As the information input apparatus 201, for example, a resistive film type, a capacitive type, an optical type, or an ultrasonic type touch panel may be used. As the optical element 1, for example, one of the optical elements 1 according to the first to seventh embodiments described above may be used.

In addition, in FIG. 17B, an example in which the optical element 1 having the base body 2 is provided on the information input element 211 is illustrated. However, the optical element 1 without the base body 2, that is, the plurality of structures 3 may be directly provided on the information input element 211. In addition, the base body 2 may also function as a base material of an upper electrode of the information input element 211.

As the display apparatus 201, for example, various display apparatuses such as a liquid crystal display, a cathode ray tube (CRT) display, a plasma display panel (PDP), an electroluminescence (EL) display, and a surface-conduction electron-emitter display (SED) may be used.

In the ninth embodiment, since the optical element 1 is provided on the information input surface of the information input apparatus 201, the anti-reflection function of the information input surface of the information input apparatus 201 can be enhanced. Therefore, visibility of the display apparatus 202 having the information input apparatus 201 can be enhanced.

### 10. Tenth Embodiment

FIG. 18A is an exploded perspective view illustrating an example of the configuration of a display apparatus including an information input apparatus according to a tenth embodiment of the present disclosure. FIG. 18B is a cross-sectional view illustrating an example of the configuration of the information input apparatus according to the tenth embodiment of the present disclosure. As illustrated in FIGS. 18A and 18B, this embodiment is different from the ninth embodiment in that an information input apparatus 201 further includes a front surface member 203 on the information input surface of an information input element 211 and an optical element 1 is provided on the front surface of the front surface member 203. The information input element 211 and the front surface member 203 are bonded by a bonding layer 213, and the front surface member 203 and the optical element 1 are bonded by, for example, a bonding layer 214.

In the tenth embodiment, since the optical element 1 is provided on the front surface member 203, the same effects as those of the ninth embodiment can be obtained.

### 11. Eleventh Embodiment

FIG. 19 is a cross-sectional view illustrating an example of the configuration of a photograph with an anti-reflection function according to an eleventh embodiment of the present disclosure. The photograph with an anti-reflection function includes a photograph 310 and an optical element 1 bonded onto the photograph 310 via a bonding layer 213.

The photograph 310 is so-called photographic paper for an ink jet printer and includes a support body 302 and an ink absorption layer 311 provided on the support body 302, and a predetermined photograph is printed on this photograph in advance. As the support body 302, for example, a resin-coated type support body such as polyolefin resin-coated paper made by applying a polyolefin resin to base paper may be used. As the ink absorption layer 311, for example, porous ceramics including inorganic pigment fine particles such as silica fine particles and titanium dioxide fine particles may be used. In addition, the photograph is not limited to the photographic paper for an ink jet printer, and for example, silver halide photographic printing paper may also be used.

### Optical Element

As the optical element 1, for example, one of the optical elements according to the first to sixth embodiments described may be used.

According to the eleventh embodiment, since the optical element 1 is provided on the photograph 310, reflection of light on the photograph surface is suppressed, and thus visibility of the photograph can be enhanced.

### EXAMPLES

Hereinafter, the present disclosure will be specifically described on the basis of Examples, and the present disclosure is not limited to these Examples.

### Example 1-1

First, a glass roll master copy having an outside diameter of 126 mm was prepared, and a resist was formed as a film on the surface of this glass master copy as follows. That is, a photoresist was diluted by a thinner with a factor of 1/10, and this diluted resist was applied to a columnar surface of the glass roll master copy into a thickness of about 130 nm by dipping, thereby forming a resist as a film. Subsequently, the glass master copy serving as a recording medium was transported to the roll master copy exposure apparatus shown in FIG. 5 and the resist was exposed, such that latent images which were connected into a single spiral shape and constituted a quasi-hexagonal lattice pattern between three adjacent rows of tracks were patterned on the resist.

Specifically, a region in which a quasi-hexagonal lattice pattern had to be formed was illuminated with a laser light at a power of 0.50 mW/m to expose up to the surface of the glass roll master copy, thereby forming a quasi-hexagonal lattice pattern having concave shapes. In addition, the thickness of the resist in the row direction of the track rows was about 120 nm, and the thickness of the resist in the extension direction of the track was about 100 nm.

Subsequently, the resist on the glass roll master copy was subjected to a developing treatment so that development was performed by dissolving the exposed portion of the resist. Specifically, an undeveloped glass roll master copy was placed on a turntable of a developing machine (not shown), and a developing liquid was dropped on the surface of the glass roll master copy during rotation on each turntable so as to develop the resist on the surface. Accordingly, a resist glass master copy in which the resist had openings in the quasi-hexagonal lattice pattern was obtained.

Next, an etching treatment and an ashing treatment were performed alternately through dry etching, so that concave portions having an elliptical cone shape in which the apex portion has a convexly curved shape were obtained. The amount of etching (depth) in the pattern at this time was changed according to an etching time. Finally, the photoresist was completely removed by O₂ ashing, thereby obtaining a moth-eye glass roll master with a quasi-hexagonal lattice pattern having a concave shape. The depth of the concave portion in the row direction was greater than the depth of the concave portion in the extension direction of the track.

Next, a UV-curable resin composition (transfer material) (UV-curable resin composition A) was prepared by blending the following materials.

| | |
|---|---|
| Urethane acrylate blend | 92 mass % |
| (40 mass % of ARONIX M-1600 of Toagosei Company, | |
| Limited + 60 mass % of violet light UV-6100B of | |
| The Nippon Synthetic Chemical Industry Co., Ltd.) | |
| Photopolymerization initiator | 3 mass % |
| (trade name Irgacure 184 produced by BASF Japan Ltd.) | |
| Modified silicone | 5 mass % |
| (polydimethylsiloxane having an acrylic group) | |

Next, a urethane film (produced by Sheedom Co., Ltd.) having a thickness of 400 μm was prepared as a base material. The elastic modulus of a resin forming the urethane film was 10 MPa. Subsequently, a UV-curable resin composition having the following composition was applied to the urethane film into a thickness of several micrometers. Thereafter, a moth-eye glass roll master was caused to come into close contact with the applied surface, and while the resultant was illuminated with ultraviolet rays for curing, peeling was performed, thereby producing an optical element. Here, by adjusting the pressure of the moth-eye glass roll master against the applied surface, a basal layer was formed between the structure and the urethane film. The elastic modulus of the resin forming the basal layer after curing was 20 MPa.

Next, the surface of the produced optical element was observed by an atomic force microscope (AFM). Subsequently, the pitch and the aspect ratio of the structures were obtained from the cross-sectional profile of the AFM. As a result, the pitch was 250 nm and the aspect ratio was 0.8.

### Example 1-2

An optical element was produced in a manner similar to that in Example 1-1 except that the blending ratio of the urethane acrylate blend was 95.75 mass % and the blending ratio of the modified silicone was 1.25 mass %.

### Example 1-3

An optical element was produced in a manner similar to that in Example 1-1 except that the blending ratio of the urethane acrylate blend was 96.375 mass % and the blending ratio of the modified silicone was 0.0625 mass %.

### Example 1-4

An optical element was produced in a manner similar to that in Example 1-1 except that the blending ratio of the urethane acrylate blend was 96.6875 mass % and the blending ratio of the modified silicone was 0.03125 mass %.

### Comparative Example 1

An optical element was produced in a manner similar to that in Example 1-1 except that the blending ratio of the urethane acrylate blend was 97 mass % and the blending ratio of the modified silicone was 0 mass %.

### Comparative Example 2

An optical element was produced in a manner similar to that in Example 1-1 except that a UV-curable resin composition (transfer material) (UV-curable resin composition B) was prepared by blending the following materials.

### Hard Coating Agent

| | |
|---|---|
| Photo-curable resin (trade name: ARONIX M-305 produced | 92 mass % |
| by Toagosei Company, Limited) | |
| Photopolymerization initiator (trade name: Irgacure 184 | 3 mass % |
| produced by BASF Japan Ltd.) | |
| Fluorine-based monomer (trade name: FA-108 produced by | 5 mass % |
| Kyoeisha Chemical Co., Ltd.) | |

### Measurement of Elastic Modulus and Measurement of Elongation Rate

### Measurement of Elastic Modulus

A flat film was produced of the UV-curable resin composition used for producing the optical element (UV curing), a dumbbell-shaped specimen (effective sample width of 5 mm) specified in JIS K7311 was prepared, and measurement was performed by a precision universal tester Autograph AG-5kNX produced by Shimadzu Corporation. The results are shown in Table 1. In the case of a small sample from which the above-described sample is not obtained, it is also possible to perform the measurement using a micro hardness tester, for example, PICODENTOR HM-500 produced by Fischer Instruments K.K.

In addition, the elastic modulus of the optical element in which the moth-eye pattern was formed was measured using a surface coating property tester (trade name: FISCHERSCOPE HM-500 produced by Fischer Instruments K.K.). As a result, the value of the elastic modulus measured by the surface coating property tester and the value of the elastic modulus of the material itself measured using a tensile tester were substantially equal to each other.

### Measurement of Elongation Rate

Elongation Rates were measured simultaneously with the elastic moduli.

### Measurement of Coefficient of Kinetic Friction

Using HEIDON SURFACE PROPERTY TESTER TYPE: 14 DR produced by Shinto Scientific Co., Ltd., the produced optical element and a sliding piece were caused to come into close contact with each other, and the coefficient of kinetic friction therebetween was measured.

A normal force line was generated by a spherical sliding piece of φ7.5 mm. In order to exert a uniform pressure distribution, the sliding piece was covered with flannel cloth produced by Kowa Company, Ltd. The total mass of the sliding piece was 200 g. During movement that causes friction, vibration has to be absent, and measurement of the coefficient of kinetic friction was performed in a section of 30 mm at 120 mm/min. The evaluation results are shown in Tables 2 and 3.

### Wear Test

Using a color fastness rubbing tester AB-301 produced by Tester Sangyo Co., Ltd., the produced optical element and the sliding piece were caused to come into close contact with each other, and a wear test was performed.

A normal force line was generated by a sliding piece of a 5 cm angle. In order to exert a uniform pressure distribution, the sliding piece was covered with flannel cloth produced by Kowa Company, Ltd. The total mass of the sliding piece was 100 g. Movement that causes friction was performed 30 reciprocations for 1 minute, total 5000 times.

After the test, the eye and the sample were separated at an interval of 30 cm, and cracks were confirmed by transmitted light. Next, a black paint was applied to the rear surface, and wear was confirmed by reflected light at a distance of 5 cm. The evaluation results are shown in Tables 2 and 3. In addition, in Tables 2 and 3, “0”, “A”, and “x” represent the following evaluation results.

◯: The rear surface is painted in black, and wear was not confirmed by the reflected light even during close observation.

Δ: Although wear is confirmed during confirmation using the reflected light, wear is not confirmed even during observation using the transmitted light at a distance of 30 CM.

x: wear is noticeable.

In addition, during confirmation using the reflected light in the case where the rear surface was painted in black, when the number of pieces of wear seen as cracks is equal to or less than 10 in a width of 5 cm, wear can be confirmed during confirmation using the reflected light. However, there is a tendency of wear not to be confirmed even during observation using the transmitted light at a distance of 30 cm (the evaluation result represented by “Δ”).

In addition, it is discovered from tests that in terms of practical use, when cracks are not confirmed by the transmitted light while the interval between the eye and the sample is 30 cm, a range in practical use can be determined.

### Fingerprint Wiping Test

After fingerprints were adhered to the surface of the optical element on the moth-eye pattern formation side, using COTTON CIEGAL (produced by Chiyoda paper manufacturing Co., Ltd.), 10 reciprocations of dry cloth wiping was performed at a pressure of about 18 kPa for 5 seconds. Evaluation of the wiping performance was performed by comparing reflectances before the adhesion of the fingerprints and after the dry cloth wiping. In the case where the reflectances before the adhesion of the fingerprints and after the dry cloth wiping have the same value, it was assumed that dry cloth wiping was possible. In Table 1, the case where dry cloth wiping is possible is represented by ◯, and the case where dry cloth wiping is not possible is represented by x.

### Luminous Reflectance

First, a treatment of cutting reflection from the rear surface of the optical element was performed by bonding a black tape to the rear surface side of the optical element as a sample. Next, a reflectance spectrum was measured using a ultraviolet-visible spectrophotometer (trade name: V-500 produced by JASCO Corporation). During measurement, a unit of specular reflection 5° was used. Subsequently, a luminous reflectance was obtained from the measured reflectance spectrum on the basis of JIS Z8701-1982.

Table 1 shows the results of the measurement of elastic modulus and the measurement of elongation rate of the UV-curable resin composition used for producing the optical elements of Examples 1-1 to 1-4 and Comparative Example 1.

TABLE 1

| | ELASTIC MODULUS | ELONGATION RATE |
|---|---|---|
| RESIN NAME | (1%) [Mpa] | [%] |
| UV-CURABLE RESIN | 31.1 | 66 |
| COMPOSITION A | | |
| UV-CURABLE RESIN | 3300 | 5.5 |
| COMPOSITION B | | |

Table 2 shows the results of the measurement of the coefficient of kinetic friction, the wear test, and the fingerprint wiping test of the optical elements of Examples 1-1 to 1-4 and Comparative Example 1, and the luminous reflectances of Example 1-2 and Comparative Example 1.

TABLE 2

| | | | | | LUMINOUS REFLECTANCE [%] | | |
|---|---|---|---|---|---|---|---|
| | SILICONE | COEFFICIENT | | | BEFORE | AFTER | |
| | DENSITY | OF KINETIC | WEAR | FINGERPRINT | WEAR | WEAR | |
| | [MASS %] | FRICTION | TEST | WIPING | TEST | TEST | DIFFERENCE |
| EXAMPLE 1-1 | 5 | 0.66 | ◯ | ◯ | — | — | — |
| EXAMPLE 1-2 | 1.25 | 0.70 | ◯ | ◯ | 0.175 | 0.182 | 0.007 |
| EXAMPLE 1-3 | 0.0625 | 0.74 | ◯ | ◯ | — | — | — |
| EXAMPLE 1-4 | 0.03125 | 0.80 | ◯ | ◯ | — | — | — |
| COMPARATIVE | 0 | 0.92 | X | ◯ | 0.17 | 3.13 | 2.96 |
| EXAMPLE 1 | | | | | | | |

Table 3 shows the results of the measurement of the coefficient of kinetic friction, the wear test, and the fingerprint wiping test of the optical element of Comparative Example 2 and luminous reflectances.

TABLE 3

| | COEFFICIENT | | | LUMINOUS REFLECTANCE [%] | | |
|---|---|---|---|---|---|---|
| | OF KINETIC | WEAR | FINGERPRINT | BEFORE | AFTER | |
| | FRICTION | TEST | WIPING | WEAR TEST | WEAR TEST | DIFFERENCE |
| COMPARATIVE | 0.60 | X | X | 0.17 | 3.13 | 2.96 |
| EXAMPLE 2 | | | | | | |

From Tables 1 to 3, the followings are found. When the coefficient of kinetic friction is equal to or less than 0.85, cracks are less likely to be visually recognized.

When the coefficient of kinetic friction is equal to or less than 0.8, wear tends to occur.

In Example 1-2 in which the coefficient of kinetic friction was equal to or less than 0.85, a change in luminous reflectance before and after the friction test was suppressed and had an extremely small value of 0.007%. For this, in Comparative Examples 1 and 2 in which the coefficient of kinetic friction exceeded 0.85, a change in luminous reflectance before and after the friction test was high and had a high value of 2.96%.

It is thought that the difference in the change in luminance reflectance between the above-described samples is caused by the following factors. That is, in Example 1-2 in which the coefficient of kinetic friction is equal to or less than 0.85, since stickiness of the surface of the structure is suppressed and adhesion between the adjacent structures is suppressed, it is thought that the anti-reflection function of the structures (moth-eye) is rarely damaged. On the contrary, in Comparative Examples 1 and 2 in which the coefficient of kinetic friction exceeds 0.85, since stickiness of the surface of the structure is not suppressed and adjacent structures are adhered to each other, it is thought that the anti-reflection function of the structures (moth-eye) is damaged.

### Examples 2-1 to 2-4 and Comparative Example 3

Optical elements were produced in a manner similar to that in Examples 1-1 to 1-4 and Comparative Example 1 except that the pitch of the structure was 250 nm and the aspect ratio of the structures was 0.75.

### Examples 3-1 to 3-3 and Comparative Examples 4 and 5

Optical elements were produced in a manner similar to that in Examples 1-1 to 1-4 and Comparative Example 1 except that the pitch of the structure was 250 nm and the aspect ratio of the structures was 1.2.

### Measurement of Coefficient of Kinetic Friction, Wear Test, and Fingerprint Wiping Test

Measurement of the coefficient of kinetic friction, the wear test, and the fingerprint wiping test on the optical elements produced as described above were performed in a manner similar to that in Examples 1-1 to 1-4 and Comparative Examples 1 and 2. The results are shown in Table 4.

Table 4 shows the results of the measurement of the coefficient of kinetic friction, the wear test, and the fingerprint test of the optical elements of Examples 2-1 to 2-4 and Comparative Example 3. Table 5 shows the results of the measurement of the coefficient of kinetic friction, the wear test, and the fingerprint test of the optical elements of Examples 3-1 to 3-3 and Comparative Examples 4 and 5.

TABLE 4

| | | | CO- | | |
|---|---|---|---|---|---|
| | SILICONE | | EFFICIENT | | FINGER- |
| | DENSITY | ASPECT | OF | WEAR | PRINT |
| | [%] | RATIO | FRICTION | TEST | WIPING |
| EXAM- | 5 | 0.75 | 0.66 | ◯ | ◯ |
| PLE 2-1 | | | | | |
| EXAM- | 1.25 | | 0.70 | ◯ | ◯ |
| PLE 2-2 | | | | | |
| EXAM- | 0.0625 | | 0.74 | ◯ | ◯ |
| PLE 2-3 | | | | | |
| EXAM- | 0.03125 | | 0.80 | ◯ | ◯ |
| PLE 2-4 | | | | | |
| COM- | 0 | | 0.92 | X | ◯ |
| PARA- | | | | | |
| TIVE | | | | | |
| EXAM- | | | | | |
| PLE 3 | | | | | |

TABLE 5

| | | | CO- | | |
|---|---|---|---|---|---|
| | SILICONE | | EFFICIENT | | FINGER- |
| | DENSITY | ASPECT | OF | WEAR | PRINT |
| | [%] | RATIO | FRICTION | TEST | WIPING |
| EXAM- | 5 | 1.2 | 0.75 | ◯ | ◯ |
| PLE 3-1 | | | | | |
| EXAM- | 1.25 | | 0.82 | ◯ | ◯ |
| PLE 3-2 | | | | | |
| EXAM- | 0.0625 | | 0.85 | Δ | ◯ |
| PLE 3-3 | | | | | |
| COM- | 0.03125 | | 0.89 | X | ◯ |
| PARA- | | | | | |
| TIVE | | | | | |
| EXAM- | | | | | |
| PLE 4 | | | | | |
| COM- | 0 | | 0.93 | X | ◯ |
| PARA- | | | | | |
| TIVE | | | | | |
| EXAM- | | | | | |
| PLE 5 | | | | | |

From Tables 4 and 5, it can be seen that the results of the wear test and the wiping performance test do not depend on the aspect ratio of the structures.

### Example 4

Transfer (production) of the optical elements of Example 1-2 was repeated, and the measurement of the coefficient of kinetic friction, the measurement of the contact angle, the fingerprint wiping test, and the wear test were performed on the optical elements produced a predetermined transfer times (production times). The results are shown in Table 6.

In addition, the measurement of the coefficient of kinetic friction, the fingerprint wiping test, and the wear test were performed in a manner similar to that in Examples 1-1 to 2-4 and Comparative Examples 1 to 5.

The measurement of the contact angle was performed as follows.

### Measurement of Contact Angle

The contact angle of the surface of the optical element on the moth-eye pattern formation side was measured by a contact angle meter (product name CA-XE Model produced by Kyowa Interface Science Co., Ltd.). As a liquid for measuring the contact angle, oleic acid was used.

### Comparative Example 6

The measurement of the coefficient of kinetic friction, the measurement of the contact angle, and the fingerprint wiping test, and the wear test were performed a predetermined transfer times in a manner similar to that in Example 4 except that a UV-curable resin composition (transfer material) was produced by blending the same materials as those in Comparative Example 2. The results are shown in Table 7.

Table 6 shows the results of the measurement of the coefficient of kinetic friction, the measurement of the contact angle, the fingerprint wiping test, and the wear test on the optical elements of Example 4 produced at the 1^{st} and 63^{rd} transfers.

TABLE 6

| | 1^{ST} TRANSFER | 63^{RD} TRANSFER |
|---|---|---|
| COEFFICIENT OF FRICTION | 0.70 | 0.77 |
| CONTACT ANGLE | 15.2 DEGREES | 15.4 DEGREES |
| (OLEIC ACID) | | |
| FINGERPRINT WIPING | ◯ | ◯ |
| WEAR TEST | ◯ | ◯ |

Table 7 shows the results of the measurement of the coefficient of kinetic friction, the measurement of the contact angle, the fingerprint wiping test, and the wear test on the optical elements of Comparative Example 6 produced at the 1^{st} and 63^{rd} transfers.

TABLE 7

| | 1^{ST} TRANSFER | 63^{RD} TRANSFER |
|---|---|---|
| COEFFICIENT OF FRICTION | 0.75 | 0.9 |
| CONTACT ANGLE | 98 DEGREES | 18 DEGREES |
| (OLEIC ACID) | | |
| FINGERPRINT WIPING | ◯ | ◯ |
| WEAR TEST | ◯ | X |

From Tables 6 and 7, the following can be seen. Wear was suppressed even after the 63^{rd} transfer in Example 4 in which a silicone-based additive was used, whereas wear was noticeable after the 63^{rd} transfer in Comparative Example 6 in which a fluorine-based additive was used.

In a system in which a silicone additive was used, replicas at the 1^{st} and 63^{rd} transfers, there was no change in the coefficient of kinetic friction, the contact angle of the oleic acid, and the fingerprint wiping performance. However, in a system in which the fluorine-based additive was used, properties obtained at the 1^{st} transfer and the 63^{rd} transfer were different. The reason is that whenever the transfer is repeated, the release agent of the master copy was deteriorated, and the fluorine-based additive could not be exhibited on the moth-eye surface.

Therefore, it can be seen that as the UV-curable resin composition, in terms of continuous transfer, a UV-curable resin composition to which the silicone-based additive was added is preferable.

### Sample 1-1

First, a glass roll master copy having an outside diameter of 126 mm was prepared, and a resist was formed as a film on the surface of this glass master copy as follows. That is, a photoresist was diluted by a thinner with a factor of 1/10, and this diluted resist was applied to a columnar surface of the lass roll master copy into a thickness of 130 nm by dipping, thereby forming a resist as a film. Subsequently, the glass master copy serving as a recording medium was transported to the roll master copy exposure apparatus shown in FIG. 5 and the resist was exposed, such that latent images which were connected into a single spiral shape and constituted a quasi-hexagonal lattice pattern between three adjacent rows of tracks were patterned on the resist.

Specifically, a region in which a hexagonal lattice pattern had to be formed was illuminated with a laser light at a power of 0.50 mW/m to expose up to the surface of the glass roll master copy, thereby forming a quasi-hexagonal lattice pattern having concave shapes. In addition, the thickness of the resist in the row direction of the track rows was about 120 nm, and the thickness of the resist in the extension direction of the track was about 100 nm.

Subsequently, the resist on the glass roll master copy was subjected to a developing treatment so that development was performed by dissolving the exposed portion of the resist. Specifically, an undeveloped lass roll master copy was placed on a turntable of a developing machine (not shown), and a developing liquid was dropped on the surface of the glass roll master copy during rotation on each turntable so as to develop the resist on the surface. Accordingly, a resist glass master copy in which the resist had openings in the quasi-hexagonal lattice pattern was obtained.

Next, an etching treatment and an ashing treatment were performed alternately through dry etching, so that concave portions having an elliptical cone shape were obtained. The amount of etching (depth) in the pattern at this time was changed according to an etching time. Finally, the photoresist was completely removed by O₂ ashing, thereby obtaining a moth-eye glass roll master with a quasi-hexagonal lattice pattern having a concave shape. The depth of the concave portion in the row direction was greater than the depth of the concave portion in the extension direction of the track.

The moth-eye glass roll master and a polymethyl methacrylate resin (PMMA) sheet coated with several micrometers in thickness of a UV-curable resin composition having the following composition were caused to come into close contact with, and while the resultant was illuminated with ultraviolet rays for curing, peeling was performed, thereby producing an optical element.

Then, a fluorine treatment was performed by dip-coating the surface of the optical element on which the moth-eye pattern is formed with a fluorine-based treatment agent (trade name OPTOOL DSX produced by Daikin Chemicals Sales, Ltd.). In this manner, an optical element of Sample 1-1 was produced.

### UV-Curable Resin Composition

| | |
|---|---|
| Polyester acrylate oligomer | 80 parts by mass |
| (trade name CN2271E produced by Sartomer | |
| Company, Inc.) | |
| Low-viscosity monoacrylate oligomer | 20 parts by mass |
| (trade name CN152 produced by Sartomer | |
| Company, Inc.) | |
| Photopolymerization initiator | 4 wt % |
| (trade name DAROCUR1173 produced by | |
| Ciba Specialty Chemicals Corporation) | |

In addition, the addition amount (4 wt %) of the photopolymerization initiator is an addition amount in the case where 100 wt % of a UV resin composition was used (similar in Samples 1-2 to 6-3 below).

### Sample 1-2

A quasi-hexagonal lattice pattern having a pitch and an aspect ratio different from those of Sample 1-1 was recorded on a resist layer by patterning a resist layer while the frequency of the polarity reversal formatter signal, the number of revolutions of the roll, and the appropriate feed pitch were adjusted for each track. An optical element of Sample 1-2 was produced in a manner similar to that in Sample 1-1 except for those described above.

### Sample 1-3

A quasi-hexagonal lattice pattern having a pitch and an aspect ratio different from those of Sample 1-1 was recorded on a resist layer by patterning a resist layer while the frequency of the polarity reversal formatter signal, the number of revolutions of the roll, and the appropriate feed pitch were adjusted for each track. An optical element was produced in a manner similar to that in Sample 1-1 except for those described above.

### Samples 2-1 to 2-3

Optical elements of Samples 2-1 to 2-3 were produced in a manner similar to those in Samples 1-1 to 1-3, respectively, except that a UV-curable resin composition having the following composition was used.

### Ultraviolet Curable Resin Composition

| | |
|---|---|
| Polyester acrylate oligomer | 30 parts by mass |
| (trade name CN2271E produced by Sartomer | |
| Company, Inc.) | |
| Difunctional acrylate | 70 parts by mass |
| (trade name Viscoat310HP produced by Osaka | |
| Organic Chemical Industry Ltd.) | |
| Photopolymerization initiator | 4 wt % |
| (trade name DAROCUR1173 produced by Ciba | |
| Specialty Chemicals Corporation) | |

### Samples 3-1 to 3-3

Optical elements of Samples 3-1 to 3-3 were produced in a manner similar to those in Samples 1-1 to 1-3, respectively, except that a UV-curable resin composition having the following composition was used.

### UV-Curable Resin Composition

| | |
|---|---|
| Polyester acrylate oligomer | 15 parts by mass |
| (trade name CN2271E produced by Sartomer | |
| Company, Inc.) | |
| Difunctional acrylate | 85 parts by mass |
| (trade name Viscoat310HP produced by | |
| Osaka Organic Chemical Industry Ltd.) | |
| Photopolymerization initiator | 4 wt % |
| (trade name DAROCUR1173 produced by Ciba | |
| Specialty Chemicals Corporation) | |

### Samples 4-1 to 4-3

Optical elements of Samples 4-1 to 4-3 were produced in a manner similar to those in Samples 1-1 to 1-3, respectively, except that a UV-curable resin composition having the following composition was used.

### UV-Curable Resin Composition

| | |
|---|---|
| Polyester acrylate oligomer | 5 parts by mass |
| (trade name CN2271E produced by Sartomer | |
| Company, Inc.) | |
| Difunctional acrylate | 95 parts by mass |
| (trade name Viscoat310HP produced by | |
| Osaka Organic Chemical Industry Ltd.) | |
| Photopolymerization initiator | 4 wt % |
| (trade name DAROCUR1173 produced by Ciba | |
| Specialty Chemicals Corporation) | |

### Samples 5-1 to 5-3

Optical elements of Samples 5-1 to 5-3 were produced in a manner similar to those in Samples 1-1 to 1-3, respectively, except that a UV-curable resin composition having the following composition was used.

### UV-Curable Resin Composition

| | |
|---|---|
| Difunctional acrylate | 80 parts by mass |
| (trade name Viscoat310HP produced by Osaka | |
| Organic Chemical Industry Ltd.) | |
| Pentafunctional urethane acrylate | 20 parts by mass |
| (trade name UA510H produced by Kyoeisha | |
| Chemical Co., Ltd.) | |
| Photopolymerization initiator | 4 wt % |
| (trade name DAROCUR1173 produced by | |
| Ciba Specialty Chemicals Corporation) | |

### Samples 6-1 to 6-3

Optical elements of Sample 6-1 to Sample 6-3 were produced in manners similar to those in Samples 1-1 to 1-3, respectively, except that the process of performing the fluorine treatment on the surface of the optical element on which the moth-eye pattern is formed was omitted.

### Evaluation of Shape

The produced optical elements of Sample 1-1 to Sample 6-3 were observed by an atomic force microscope (AFM). Then, the pitch and the aspect ratio of the structures of each of Samples were obtained from the sectional profile of the ATM. The results thereof are shown in Table 8.

### Measurement of Contact Angle

The contact angle of the surface of the optical element on the moth-eye pattern formation side was measured by a contact angle meter (product name CA-XE Model produced by Kyowa Interface Science Co., Ltd.). As a liquid for measuring the contact angle, oleic acid was used.

### Evaluation of Wiping Performance

After fingerprints were adhered to the surface of the optical element on the moth-eye pattern formation side, dry cloth wiping was performed 10 reciprocations for 5 seconds at a pressure of about 18 kPa using COTTON CIEGAL (produced by Chiyoda paper manufacturing Co., Ltd). The wiping performance was evaluated by comparing the reflectances before the adhesion of the fingerprints and after the dry cloth wiping. In a case where the reflectances before the adhesion of the fingerprints and after the dry cloth wiping have the same value, it was assumed that dry cloth wiping was possible. In Table 8, the case where dry cloth wiping is possible is represented by ◯, and the case where dry cloth wiping is not possible is represented by x. Regarding the reflectance, the reflectance of visible light with a wavelength of 532 nm was measured using an evaluation apparatus (trade name V-550 produced by JASCO Corporation). The results thereof are shown in Table 8.

### Measurement of Elastic Modulus

Measurement with Tensile Tester

A flat film was produced (UV-cured) of the same material as that of the UV-curable resin composition used for producing the optical element, and was cut into a film sample in a shape of 14 mm in width, 50 mm in length, and about 200 μm in thickness for use. The elastic modulus of the film sample was measured on the basis of JIS K7127 using a tensile tester (trade name AG-X produced by Shimadzu Corporation). The results thereof are shown in Table 8.

Furthermore, the elastic modulus of the optical element in which the moth-eye pattern was formed was measured using a surface coating property tester (FISCHERSCOPE HM-500 produced by Fischer Instruments K.K.). As a result, the value of the elastic modulus measured by a micro hardness tester and the value of the elastic modulus of the material itself measured by using a tensile tester were substantially equal to each other.

TABLE 8

| | | | | | | | WIPING PROPERTIES | | | |
|---|---|---|---|---|---|---|---|---|---|---|
| | | | | | | | REFLECTANCE | | | |
| | | | | ELAS- | | OLEIC | BEFORE | | | |
| | SHAPE | | | TIC | | ACID | FINGER- | AFTER | DE- | |
| | | | AS- | MODU- | FLUOR- | CONTACT | PRINT | FINGER- | TER- | |
| | ARRANGEMENT OF | PITCH | PECT | LUS | INE | ANGLE | ATTACH- | PRINT | MINA- | |
| | STRUCTURES | [nm] | RATIO | [MPa] | COAT | [DEGREE] | MENT | WIPING | TION | NOTE |
| SAMPLE 1-1 | QUASI-HEXAGONAL | 300 | 0.33 | 29 | YES | 105 | 1.9 | 1.9 | ◯ | EASILY |
| | LATTICE | | | | | | | | | SLID AND |
| | | | | | | | | | | EASILY |
| | | | | | | | | | | WIPED |
| SAMPLE 1-2 | QUASI-HEXAGONAL | 280 | 0.61 | | YES | 123 | 0.2 | 0.2 | ◯ | |
| | LATTICE | | | | | | | | | |
| SAMPLE 1-3 | QUASI-HEXAGONAL | 250 | 1.20 | | YES | 127 | 0.5 | 0.5 | ◯ | |
| | LATTICE | | | | | | | | | |
| SAMPLE 2-1 | QUASI-HEXAGONAL | 300 | 0.33 | 188 | YES | 104 | 1.9 | 1.9 | ◯ | — |
| | LATTICE | | | | | | | | | |
| SAMPLE 2-2 | QUASI-HEXAGONAL | 280 | 0.61 | | YES | 120 | 0.2 | 0.2 | ◯ | |
| | LATTICE | | | | | | | | | |
| SAMPLE 2-3 | QUASI-HEXAGONAL | 250 | 1.20 | | YES | 122 | 0.5 | 0.5 | ◯ | |
| | LATTICE | | | | | | | | | |
| SAMPLE 3-1 | QUASI-HEXAGONAL | 300 | 0.33 | 535 | YES | 85 | 1.9 | 2.7 | X | — |
| | LATTICE | | | | | | | | | |
| SAMPLE 3-2 | QUASI-HEXAGONAL | 280 | 0.61 | | YES | 105 | 0.2 | 0.2 | ◯ | |
| | LATTICE | | | | | | | | | |
| SAMPLE 3-3 | QUASI-HEXAGONAL | 250 | 1.20 | | YES | 114 | 0.5 | 0.5 | ◯ | |
| | LATTICE | | | | | | | | | |
| SAMPLE 4-1 | QUASI-HEXAGONAL | 300 | 0.33 | 1140 | YES | 75 | 1.9 | 3.1 | X | — |
| | LATTICE | | | | | | | | | |
| SAMPLE 4-2 | QUASI-HEXAGONAL | 280 | 0.61 | | YES | 90 | 0.2 | 0.2 | ◯ | |
| | LATTICE | | | | | | | | | |
| SAMPLE 4-3 | QUASI-HEXAGONAL | 250 | 1.20 | | YES | 107 | 0.5 | 0.5 | ◯ | |
| | LATTICE | | | | | | | | | |
| SAMPLE 5-1 | QUASI-HEXAGONAL | 300 | 0.33 | 1920 | YES | 93 | 1.9 | 2.9 | X | — |
| | LATTICE | | | | | | | | | |
| SAMPLE 5-2 | QUASI-HEXAGONAL | 280 | 0.61 | | YES | 104 | 0.2 | 2.7 | X | |
| | LATTICE | | | | | | | | | |
| SAMPLE 5-3 | QUASI-HEXAGONAL | 250 | 1.20 | | YES | 107 | 0.5 | 2.6 | X | |
| | LATTICE | | | | | | | | | |
| SAMPLE 6-1 | QUASI-HEXAGONAL | 300 | 0.33 | 29 | NO | 15 | 1.9 | 1.9 | ◯ | NOT |
| | LATTICE | | | | | | | | | EASILY |
| SAMPLE 6-2 | QUASI-HEXAGONAL | 280 | 0.61 | | NO | 15 | 0.2 | 0.2 | ◯ | SLID AND |
| | LATTICE | | | | | | | | | NOT EASILY |
| SAMPLE 6-3 | QUASI-HEXAGONAL | 250 | 1.20 | | NO | 12 | 0.5 | 0.5 | ◯ | WIPED. IF |
| | LATTICE | | | | | | | | | FINGERPRINT |
| | | | | | | | | | | IS ADHERED, |
| | | | | | | | | | | THE |
| | | | | | | | | | | FINGERPRINT |
| | | | | | | | | | | INFILTRATES |
| | | | | | | | | | | INTO PLACE |
| | | | | | | | | | | GREATER |
| | | | | | | | | | | THAN |
| | | | | | | | | | | THAT HAVING |
| | | | | | | | | | | FINGERPRINT |
| | | | | | | | | | | ADHERED |

### Evaluation

As shown in Table 8, regarding Samples 5-1 to 5-3, in the evaluation of the wiping performance, dry cloth wiping was difficult. This is because the elastic moduli of the optical elements are out of the range of 5 MPa to 1200 MPa.

In addition, according to the comparison between Samples 1-1 to 1-3 and Samples 6-1 to 6-3, in the evaluation of the wiping performance, regarding Samples 1-1 to 1-3, COTTON CIEGAL slid easily and fingerprints were wiped off easily. On the other hand, regarding Samples 6-1 to 6-3, COTTON CIEGAL did not slide easily and when fingerprints were adhered, fingerprints infiltrate and spread to a large extent from the place where the fingerprints were adhered. This is because regarding Samples 1-1 to 1-3, the surface of the optical element on which the moth-eye pattern was formed was subjected to fluorine coating and regarding Samples 6-1 to 6-3, fluorine coating was not performed.

Regarding the following samples, the thicknesses of the base body, the base material, or the basal layer were measured as follows.

The optical element was cut, a photograph of the cross-section thereof was taken by a scanning electron microscope (SEM), and the thicknesses of the base body, the base material, or the basal layer were measured from the taken SEM photograph.

Regarding the following samples, the elastic moduli of the base body, the base material, or the basal layer were measured as follows.

A dumbbell-shaped test piece (effective sample width of mm) specified in JIS K7311 was prepared, and measurement was performed by a precision universal tester Autograph AG-5kNX produced by Shimadzu Corporation. In the case of a small sample from which the above-described sample is not obtained, it is also possible to perform the measurement using a micro hardness tester, for example, PICODENTOR HM500 produced by Fischer Instruments K.K. Moreover, in the case of a still smaller sample, the measurement may be performed by the AFM (refer to “Koubunshi Nano Zairyou (Polymer Nano-Material)” issued by Kyoritsu Shuppan Co., Ltd., P.81 to P.111).

### Sample 7-1

First, a glass roll master copy having an outside diameter of 126 mm was prepared, and a resist was formed as a film on the surface of this glass master copy as follows. That is, a photoresist was diluted by a thinner with a factor of 1/10, and this diluted resist was applied to a columnar surface of the glass roll master copy into a thickness of 130 nm by dipping, thereby forming a resist as a film. Subsequently, the glass master copy serving as a recording medium was transported to the roll master copy exposure apparatus shown in FIG. 5 and the resist was exposed, such that latent images which were connected into a single spiral shape and constituted a quasi-hexagonal lattice pattern between three adjacent rows of tracks were patterned on the resist.

Specifically, a region in which a hexagonal lattice pattern had to be formed was illuminated with a laser light at a power of 0.50 mW/m to expose up to the surface of the glass roll master copy, thereby forming a quasi-hexagonal lattice pattern having concave shapes. In addition, the thickness of the resist in the row direction of the track rows was about 120 nm, and the thickness of the resist in the extension direction of the track was about 100 nm.

Subsequently, the resist on the glass roll master copy was subjected to a developing treatment so that development was performed by dissolving the exposed portion of the resist. Specifically, an undeveloped glass roll master copy was placed on a turntable of a developing machine (not shown), and a developing liquid was dropped on the surface of the glass roll master copy during rotation on each turntable so as to develop the resist on the surface. Accordingly, a resist glass master copy in which the resist layer had openings in the quasi-hexagonal lattice pattern was obtained.

Next, an etching treatment and an ashing treatment were performed alternately through dry etching, so that concave portions having an elliptical cone shape were obtained. The amount of etching (depth) in the pattern at this time was changed according to an etching time. Finally, the photoresist was completely removed by O₂ ashing, thereby obtaining a moth-eye glass roll master with a quasi-hexagonal lattice pattern having a concave shape. The depth of the concave portion in the row direction was greater than the depth of the concave portion in the extension direction of the track.

Next, a urethane film (produced by Sheedom Co., Ltd.) having a thickness of 400 μm was prepared as a base material. The elastic modulus of a resin forming the urethane film was 5 MPa. Subsequently, a UV-curable resin composition having the following composition was applied to the urethane film into a thickness of several micrometers. Thereafter, a moth-eye glass roll master was caused to come into close contact with the applied surface, and while the resultant was illuminated with ultraviolet rays for curing, peeling was performed, thereby producing an optical element. Here, by adjusting the pressure of the moth-eye glass roll master against the applied surface, a basal layer was formed into 20 nm between the structure and the urethane film. The elastic modulus of the resin forming the basal layer after curing was 20 MPa.

### UV-Curable Resin Composition

| | |
|---|---|
| Polyester acrylate oligomer | 80 parts by mass |
| (trade name CN2271E produced by Sartomer | |
| Company, Inc.) | |
| Low-viscosity monoacrylate oligomer | 20 parts by mass |
| (trade name CN152 produced by Sartomer | |
| Company, Inc.) | |
| Photopolymerization initiator | 4 wt % |
| (trade name DAROCUR1173 produced by Ciba | |
| Specialty Chemicals Corporation) | |

Then, a fluorine treatment was performed by dip-coating the surface of the optical element on which the moth-eye pattern is formed with a fluorine-based treatment agent (trade name OPTOOL DSX produced by Daikin Chemicals Sales, Ltd.). In this manner, an optical element of Sample 7-1 having the following configuration was produced.

### Moth-Eye Configuration

Arrangement of structures: quasi-hexagonal lattice

Height: 250

Pitch: 250

Aspect ratio: 1

### Sample 7-2

An optical element of Sample 7-2 was produced in a manner similar to that in Sample 7-1 except that a basal layer having a thickness of 60 μm was formed between the structure and the urethane film by adjusting the pressure of the moth-eye glass roll master against the surface coated with the urethane film.

### Sample 7-3

An optical element of Sample 7-3 was produced in a manner similar to that in Sample 7-1 except that a basal layer having a thickness of 120 μm was formed between the structure and the urethane film by adjusting the pressure of the moth-eye glass roll master against the surface coated with the urethane film.

### Sample 7-4

An optical element of Sample 7-4 was produced in a manner similar to that in Sample 7-1 except that a basal layer having a thickness of 150 μm was formed between the structure and the urethane film by adjusting the pressure of the moth-eye glass roll master against the surface coated with the urethane film.

### Sample 8-1

An optical element of Sample 8-1 was produced in a manner similar to that in Sample 7-1 except that the thickness of the urethane film was 20 μm.

### Sample 8-2

An optical element of Sample 8-2 was produced in a manner similar to that in Sample 7-1 except that the thickness of the urethane film was 40 μm.

### Sample 8-3

An optical element of Sample 8-3 was produced in a manner similar to that in Sample 7-1 except that the thickness of the urethane film was 80 μm.

### Sample 8-4

An optical element of Sample 8-4 was produced in a manner similar to that in Sample 7-1 except that the thickness of the urethane film was 120 μm.

### Sample 8-5

An optical element of Sample 8-5 was produced in a manner similar to that in Sample 7-1 except that the thickness of the urethane film was 200 μm.

### Sample 8-6

An optical element of Sample 8-6 was produced in a manner similar to that in Sample 7-1 except that the thickness of the urethane film was 400 μm.

### Scratch Test

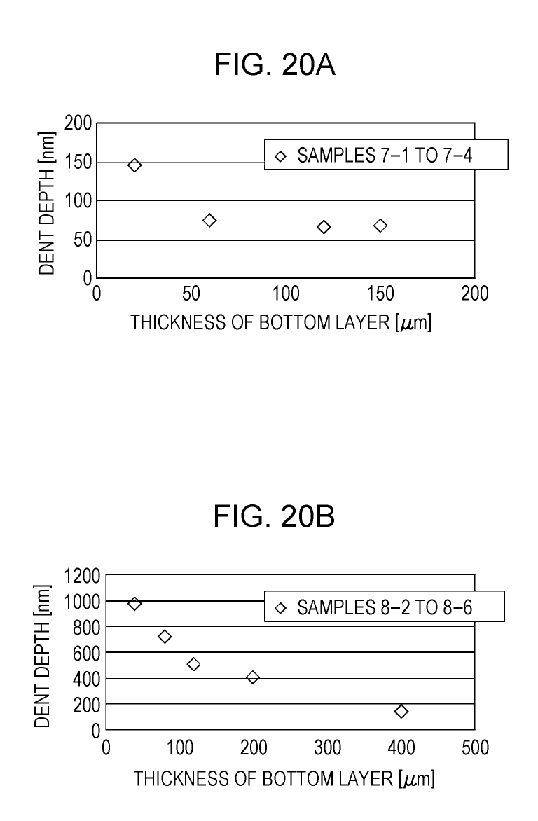

First, regarding the produced Samples 7-1 to 7-4 and 8-1 to 8-6, a scratch test was performed by the testing method based on JIS K5600-5-4. Specifically, using a hand push type scratch hardness tester (trade name No. 553-S produced by Yasuda Seiki Seisakusho, Ltd.), a sample surface was scratched with a 2H pencil. Subsequently, a trace drawn with the pencil was wiped with a soft cloth so as to remove the powder of the pencil. Thereafter, the sample surface was observed visually. Then, the depth of plastic deformation was measured by a fine shape measuring apparatus (trade name Alpha-Step 500 produced by KLA-Tencor Corporation). The results thereof are shown in Tables 9 and 10 and FIGS. 20A and 20B. In addition, in “Plastic deformation” and “Cohesive failure” in Tables 9 and 10, “◯”, “Δ”, and “x” represent the following evaluation results.

### Plastic Deformation

◯: The depth of plastic deformation is equal to or greater than 0 nm and less than 350 nm, there is no change in reflection performance, and no dent is observed visually.

Δ: The depth of plastic deformation is equal to or greater than 350 nm and less than 1000 nm, there is no change in reflection performance, and almost no dent is observed visually.

x: The depth of plastic deformation is equal to or greater than 1000 nm, the reflection performance is degraded, and a dent is clearly visually observed.

### Cohesive Failure

◯: There is no change in reflection performance, and scratch and peeling are not visually observed at all.

Δ: There is no change in reflection performance, and scratch and peeling are hardly visually observed.

x: The reflection performance is degraded, and scratch and peeling are clearly visually observed.

Table 9 shows the results of the scratch test of Samples 7-1 to 7-4.

TABLE 9

| | | SAM- | SAM- | SAM- | SAM- |
|---|---|---|---|---|---|
| | | PLE 7-1 | PLE 7-2 | PLE 7-3 | PLE 7-4 |
| ELEMENT | THICKNESS | 400 | 400 | 400 | 400 |
| CON- | OF BASE | | | | |
| FIGU- | MATERIAL | | | | |
| RATION | [μm] | | | | |
| | THICKNESS | 20 | 60 | 120 | 150 |
| | OF BOTTOM | | | | |
| | LAYER [μm] | | | | |
| EVAL- | DENT | 145 | 75 | 65 | 68 |
| UATION | DEPTH [nm] | | | | |
| | PLASTIC | ◯ | ◯ | ◯ | ◯ |
| | DEFORMATION | | | | |
| | COHESIVE | ◯ | ◯ | ◯ | ◯ |
| | FAILURE | | | | |

Table 10 shows the results of the scratch test of Samples 8-1 to 8-6. In addition, the depth of dent of plastic deformation of Sample 8-1 was out of the measurement range and thus description of the measurement value is omitted.

TABLE 10

| | | SAMPLE | SAMPLE | SAMPLE | SAMPLE | SAMPLE | SAMPLE |
|---|---|---|---|---|---|---|---|
| | | 8-1 | 8-2 | 8-3 | 8-4 | 8-5 | 8-6 |
| ELEMENT | THICKNESS OF BASE | 20 | 40 | 80 | 120 | 200 | 400 |
| CONFIGURATION | MATERIAL [μm] | | | | | | |
| | THICKNESS OF | 20 | 20 | 20 | 20 | 20 | 20 |
| | BOTTOM LAYER [μm] | | | | | | |
| EVALUATION | DENT DEPTH [nm] | — | 980 | 721 | 512 | 403 | 145 |
| | PLASTIC | X | Δ | Δ | Δ | Δ | ◯ |
| | DEFORMATION | | | | | | |
| | COHESIVE FAILURE | X | Δ | ◯ | ◯ | ◯ | ◯ |

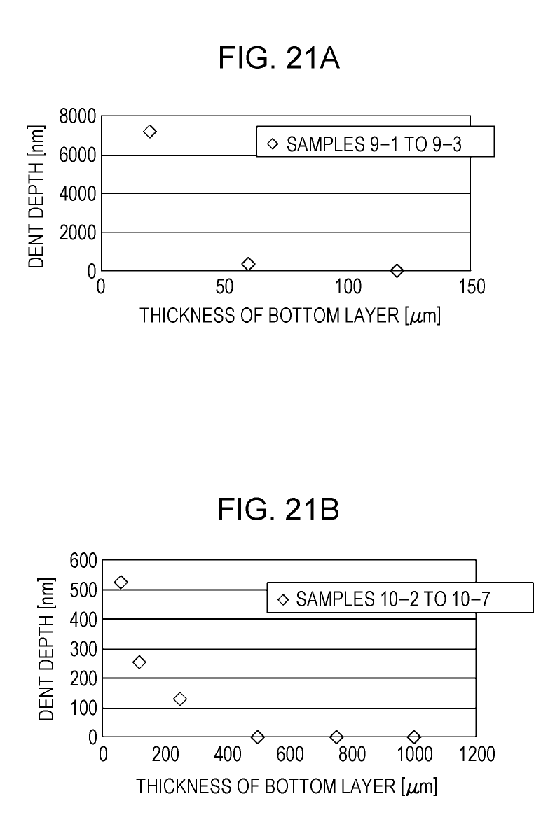

The following can be seen from Tables 9 and 10 and FIGS. 21A and 21B.

When the total thickness of the base material and the basal layer is equal to or greater than 60 μm, visual recognition of plastic deformation and cohesive failure can be suppressed.

### Sample 9-1

An optical element of Sample 9-1 was produced in a manner similar to that in Sample 7-1 except that a polymethyl methacrylate (PMMA) film having a thickness of 150 μm was used as the base material instead of the urethane film having a thickness of 400 μm. In addition, the elastic modulus of the material for the PMMA film was 3300 MPa.

### Sample 9-2

An optical element of Sample 9-2 was produced in a manner similar to that in Sample 9-1 except that a basal layer having a thickness of 60 μm was formed between the structure and the PMMA film by adjusting the pressure of the moth-eye glass roll master against the surface coated with the urethane film.

### Sample 9-3

An optical element of Sample 9-3 was produced in a manner similar to that in Sample 9-1 except that a basal layer having a thickness of 120 μm was formed between the structure and the PMMA film by adjusting the pressure of the moth-eye glass roll master against the surface coated with the urethane film.

### Scratch Test

Regarding the produced Samples 9-1 to 9-3, a scratch test as in Samples 7-1 to 7-4 described above was performed, and observation of the sample surface and measurement of the depth of plastic deformation were performed. The results thereof are shown in Table 11 and FIG. 21A.

Table 11 shows the results of the scratch test of Samples 9-1 to 9-3.

TABLE 11

| | | SAM- | SAM- | SAM- |
|---|---|---|---|---|
| | | PLE 9-1 | PLE 9-2 | PLE 9-3 |
| ELEMENT | THICKNESS OF BASE | 150 | 150 | 150 |
| CONFIGU- | MATERIAL [μm] | | | |
| RATION | THICKNESS OF | 20 | 60 | 120 |
| | BOTTOM LAYER [μm] | | | |
| EVALUATION | DENT DEPTH [nm] | 7205 | 324 | 19 |
| | PLASTIC | X | Δ | ◯ |
| | DEFORMATION | | | |
| | COHESIVE FAILURE | X | Δ | ◯ |

The following can be seen from Table 11 and FIG. 21A.

In the case where a base material having an elastic modulus out of the range of equal to or greater than 1 MPa and equal to or less than 3000 MPa is used, occurrences of plastic deformation and cohesive failure can be suppressed by causing the thickness of the basal layer to be equal to or greater than 60 μm.

### Sample 10-1

First, a glass roll master copy in which a region to be formed as a forming surface is uniformly dented and which has an outside diameter of 126 mm was prepared. Next, a moth-eye glass roll master with a quasi-hexagonal lattice pattern was obtained in a manner similar to that in Sample 7-1 except that this glass roll master copy was used. Subsequently, a UV-curable resin composition having the following composition was applied to a cycloolefin-based film. Thereafter, a moth-eye glass roll master was caused to come into close contact with the resulting applied surface, and while the resultant was illuminated with ultraviolet rays for curing, peeling was performed, thereby producing an optical element. At this time, a resin layer of 20 μm that was to be a base body was formed between the structure and the cycloolefin-based film by adjusting the pressure of the moth-eye glass roll master against the applied surface.

### UV-Curable Resin Composition

| | |
|---|---|
| Polyester acrylate oligomer | 80 parts by mass |
| (trade name CN2271E produced by Sartomer | |
| Company, Inc.) | |
| Low-viscosity monoacrylate oligomer | 20 parts by mass |
| (trade name CN152 produced by Sartomer | |
| Company, Inc.) | |
| Photopolymerization initiator | 4 wt % |
| (trade name DAROCUR1173 produced by Ciba | |
| Specialty Chemicals Corporation) | |

Then, an optical element was obtained by peeling the cycloolefin-based film from the resin layer. Next, a fluorine treatment was performed by dip-coating the surface of the optical element on which the moth-eye pattern is formed with a fluorine-based treatment agent (trade name OPTOOL DSX produced by Daikin Chemicals Sales, Ltd.). In this manner, an optical element of Sample 10-1 in which a large number of structures were formed on the base body having a thickness of 20 μm was produced.

### Sample 10-2

An optical element of Sample 10-2 was produced in a manner similar to that in Sample 7-1 except that a base body and structures were formed integrally with each other and the thickness of the base body was 60 μm.

### Sample 10-3

An optical element of Sample 10-3 was produced in a manner similar to that in Sample 7-1 except that a base body and structures were formed integrally with each other and the thickness of the base body was 120 μm.

### Sample 10-4

An optical element of Sample 10-4 was produced in a manner similar to that in Sample 7-1 except that a base body and structures were formed integrally with each other and the thickness of the base body was 250 μm.

### Sample 10-5

An optical element of Sample 10-5 was produced in a manner similar to that in Sample 7-1 except that a base body and structures were formed integrally with each other and the thickness of the base body was 500 μm.

### Sample 10-6

An optical element of Sample 10-6 was produced in a manner similar to that in Sample 7-1 except that a base body and structures were formed integrally with each other and the thickness of the base body was 750 μm.

### Sample 10-7

An optical element of Sample 10-7 was produced in a manner similar to that in Sample 7-1 except that a base body and structures were formed integrally with each other and the thickness of the base body was 1000 μm.

### Scratch Test

Regarding the produced Samples 10-1 to 10-7, a scratch test as in Samples 7-1 to 7-4 described above was performed, and observation of the sample surface and measurement of the depth of plastic deformation were performed. The results thereof are shown in Table 12 and FIG. 21B.

Table 12 shows the results of the scratch test of Samples 10-1 to 10-7. In addition, the depth of dent of plastic deformation of Sample 10-1 was out of the measurement range and thus description of the measurement value is omitted.

TABLE 12

| | | SAMPLE | SAMPLE | SAMPLE | SAMPLE | SAMPLE | SAMPLE | SAMPLE |
|---|---|---|---|---|---|---|---|---|
| | | 10-1 | 10-2 | 10-3 | 10-4 | 10-5 | 10-6 | 10-7 |
| ELEMENT | THICKNESS OF | 20 | 60 | 120 | 250 | 500 | 750 | 1000 |
| CONFIGURATION | BASE BODY | | | | | | | |
| | [μm] | | | | | | | |
| EVALUATION | DENT DEPTH | — | 523 | 255 | 128 | 0 | 0 | 0 |
| | [nm] | | | | | | | |
| | PLASTIC | X | Δ | ◯ | ◯ | ◯ | ◯ | ◯ |
| | DEFORMATION | | | | | | | |
| | COHESIVE | X | Δ | Δ | ◯ | ◯ | ◯ | ◯ |
| | FAILURE | | | | | | | |

The following can be seen from Table 12 and FIG. 21B. In the case where the structures and the base body are formed integrally with each other, occurrences of plastic deformation and cohesive failure can be suppressed by causing the thickness of the base body to be equal to or greater than 60 μm.

### Test Examples 1-1 to 1-10

The depth of a plastic deformation region when an optical film surface was pressed with a pencil was obtained by a simulation as described below.

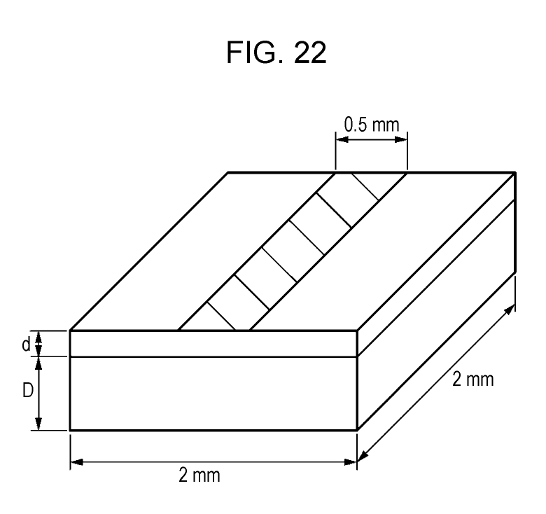

First, an optical film having a double-layer structure as illustrated in FIG. 22 was set. The setting conditions of the property values of this optical film were described as follows. In addition, ANSYS Structural (produced by ANSYS, Inc.) was used as a program.

### Base Material

Thickness D: 40 μm

Elastic modulus: 0 to 10,000 MPa

### Surface Layer

Thickness d: 20 μm

Elastic modulus: 20 MPa

Next, the depth of a plastic deformation region when a region with diagonal lines illustrated in FIG. 22 was pressed with a pencil was obtained. The pressing conditions were described as follows.

Weight of pressing: 0.75 kg

Area of pressing (area of region with diagonal lines): 2 mm×0.5 mm

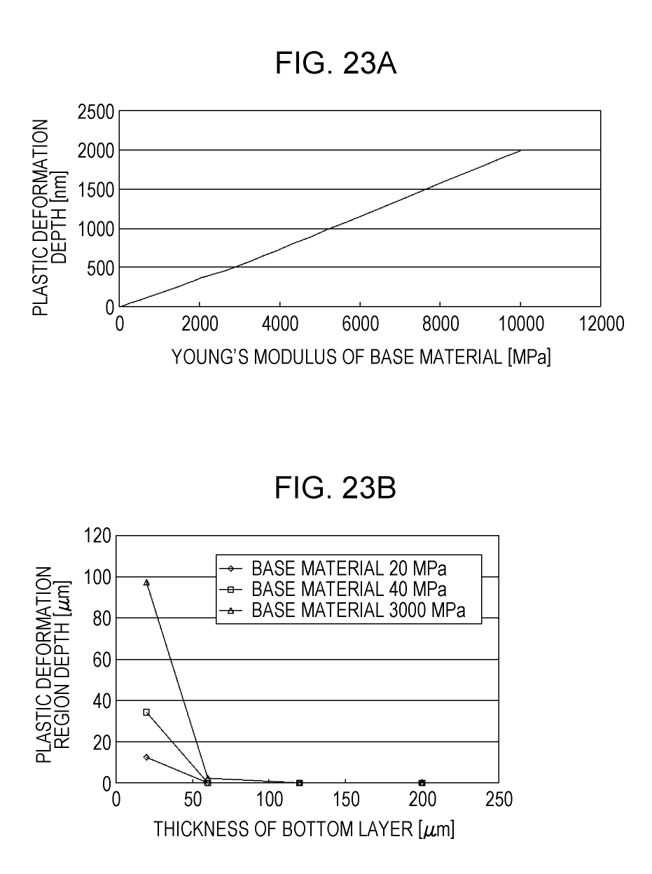

FIG. 23A is a graph showing the results of the simulations in Test Examples 1-1 to 1-10. Table 13 shows the results of the simulations in Test Examples 1-1 to 1-10. In addition, in “Plastic deformation” and “Cohesive failure” in Table 13, “◯”, “Δ”, and “x” represent the following evaluation results.

### Plastic Deformation

◯: The depth of plastic deformation is equal to or greater than 0 nm and less than 350 nm. In addition, by causing the depth of plastic deformation to be in this range, there is no change in reflection performance and no dent is observed visually.

Δ: The depth of plastic deformation is equal to or greater than 350 and less than 1000 nm. In addition, by causing the depth of plastic deformation to be in this range, there is no change in reflection performance and substantially no dent is observed visually.

x: The depth of plastic deformation is equal to or greater than 1000 nm or more. In addition, when the depth of plastic deformation is in this range, the reflection performance is degraded, and dents are visually observed.

TABLE 13

| | TEST | TEST | TEST | TEST | | | | | | |
|---|---|---|---|---|---|---|---|---|---|---|
| | EX- | EX- | EX- | EX- | TEST | TEST | TEST | TEST | TEST | TEST |
| | AMPLE | AMPLE | AMPLE | AMPLE | EXAMPLE | EXAMPLE | EXAMPLE | EXAMPLE | EXAMPLE | EXAMPLE |
| | 1-1 | 1-2 | 1-3 | 1-4 | 1-5 | 1-6 | 1-7 | 1-8 | 1-9 | 1-10 |
| YOUNG'S | 0 | 10 | 20 | 100 | 500 | 1000 | 1500 | 2000 | 3000 | 10000 |
| MODULUS | | | | | | | | | | |
| [MPa] | | | | | | | | | | |
| PLASTIC | 0 | 0.23732 | 0.48464 | 13.0768 | 82.9515 | 170.595 | 258.261 | 359.36 | 523.197 | 1987.9 |
| DEFORMATION | | | | | | | | | | |
| DEPTH [nm] | | | | | | | | | | |
| EVALUATION | ◯ | ◯ | ◯ | ◯ | ◯ | ◯ | ◯ | Δ | Δ | X |

In addition, since the height of the moth-eye structure is sufficiently small compared to the thickness of the basal layer, in the above-described simulation, the surface of the optical film is approximated by a flat surface. The result of the simulation on the basis of approximation by the flat surface is substantially the same as the result of actual measurement of plastic deformation of the optical film in which a moth-eye structure is formed.

The following can be seen from Table 13 and FIG. 23A.

The depth of plastic deformation can be caused to be in the range of equal to or greater than 350 nm and less than 1000 nm by causing the elastic modulus of the base material to be equal to or less than 3000 MPa. That is, degradation of the reflection performance can be suppressed and visually observed dents can be prevented.

Furthermore, the depth of plastic deformation can be caused to be in the range of equal to or greater than 0 nm and less than 350 nm by causing the elastic modulus of the base material to be equal to or less than 1500 MPa. That is, degradation of the reflection performance can be suppressed and visually observed dent can be further prevented.

### Test Examples 2-1 to 2-4

The depth of a plastic deformation region when the optical film surface was pressed with a pencil was obtained by simulation as described below.

First, an optical film having a double-layer structure as illustrated in FIG. 22 was set. The setting conditions of the property values of this optical film were described as follows. In addition, ANSYS Structural (produced by ANSYS, Inc.) was used as a program.

### Base Material

Thickness D: 400 μm

Elastic modulus: 20 MPa

### Surface Layer

Thickness d: 20 μm, 60 μm, 120 μm, and 200 μm

Elastic modulus: 20 MPa

Next, the depth of a plastic deformation region when a region with diagonal lines illustrated in FIG. 22 was pressed with a pencil was obtained. The pressing conditions were described as follows.

Weight of pressing: 0.75 kg

Area of pressing (area of region with diagonal lines): 2 mm×0.5 mm

### Test Examples 3-1 to 3-4

The simulation was performed in manners similar to those in Test Examples 2-1 to 2-4 except that the setting conditions of the property values of the optical film were as follows.

### Base Material

Thickness D: 400 μm

Elastic modulus: 40 MPa

### Surface Layer

Thickness d: 20 μm, 60 μm, 120 μm, and 200 μm

Elastic modulus: 20 MPa

### Test Examples 4-1 to 4-4

The simulation was performed in manners similar to those in Test Examples 2-1 to 2-4 except that the setting conditions of the property values of the optical film were as follows.

### Base Material

Thickness D: 135 μm

Elastic modulus: 3000 MPa

### Surface Layer

Thickness d: 20 μm, 60 μm, 120 μm, and 200 μm

Elastic modulus: 20 MPa

FIG. 23B is a graph showing the results of simulations in Test Examples 2-1 to 2-4, Test Examples 3-1 to 3-4, and Test Examples 4-1 to 4-4. In addition, since the height of the moth-eye structure is sufficiently small compared to the thickness of the basal layer, in the above-described simulation, the surface of the optical film is approximated by a flat surface. The result of the simulation on the basis of approximation by the flat surface is substantially the same as the result of actual measurement of plastic deformation of the optical film in which a moth-eye structure is formed.

The following can be seen from FIG. 23B.

An occurrence of plastic deformation can be suppressed by causing the thickness of the surface layer to be equal to or greater than 60 μm without depending on of the elastic modulus of the base material. Therefore, an occurrence of plastic deformation can be suppressed by causing the thickness of the basal layer of the optical element (moth-eye film) to be equal to or greater than 60 μm.

### Test Example 5

The elongation rate when the optical film surface was pressed with a pencil was obtained by a simulation as described below.

First, an optical film having a double-layer structure as illustrated in FIG. 22 was set. The setting conditions of the property values of this optical film were described as follows. In addition, ANSYS Structural (produced by ANSYS, Inc.) was used as a program.

### Base Material

Thickness D: 400 μm

Elastic modulus: 1 MPa

### Surface Layer

Thickness d: 20 μm

Elastic modulus: 1 MPa

Next, the elongation rate when a region with diagonal lines illustrated in FIG. 22 was pressed with a pencil was obtained. The pressing conditions were described as follows.

Weight of pressing: 0.75 kg

Area of pressing (area of region with diagonal lines): 2 mm×0.5 mm

From the results of the simulation, it was found that the elongation rates of the base material and the surface layer caused by the deformation due to pressing with the pencil were in a range of less than 20%. Therefore, in order to prevent breakage of the base material, it is preferable that the elongation rates of the materials forming the base material and the surface layer be set to be more than 20%.

### Test Example 6

The elongation rate for causing the structures to come into close contact with each other was obtained by a simulation as described below.

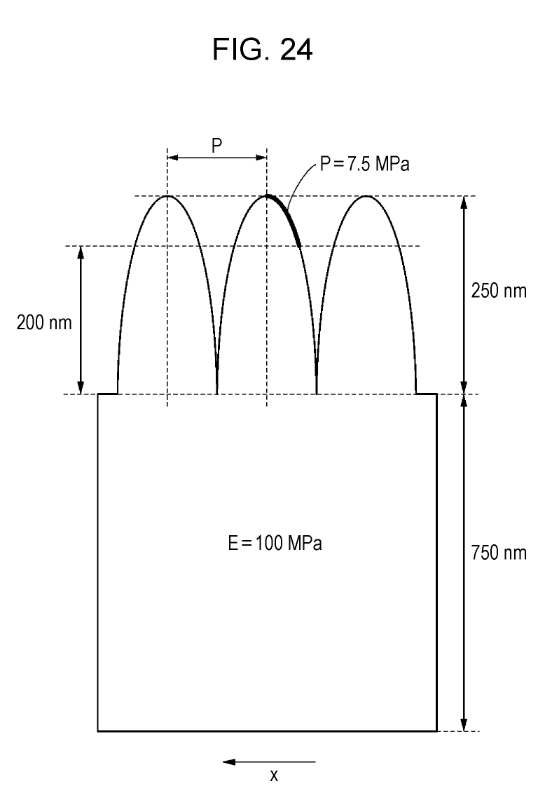

First, an optical element as illustrated in FIG. 24 was set. The setting conditions of the optical element were described as follows. In addition, ANSYS Structural (produced by ANSYS, Inc.) was used as a program.

### Base Body

Thickness: 750 nm

Elastic modulus: 100 MPa

### Nanostructure

Shape: paraboloid shape

Height: 250 nm

Pitch: 200 nm

Aspect ratio: 1.25

Number of structures: 3

Next, a weight was exerted on the structure located at the center, among three structures shown in FIG. 24, and the elongation rate when the apex portion of the structure was brought into contact with a side surface of an adjacent structure was obtained. The weight was adjusted so that a pressure of 7.5 MPa was applied to a region in range of a height of 200 nm to 250 nm in one side surface of the central structure. At this time, the bottom surface was fixed.

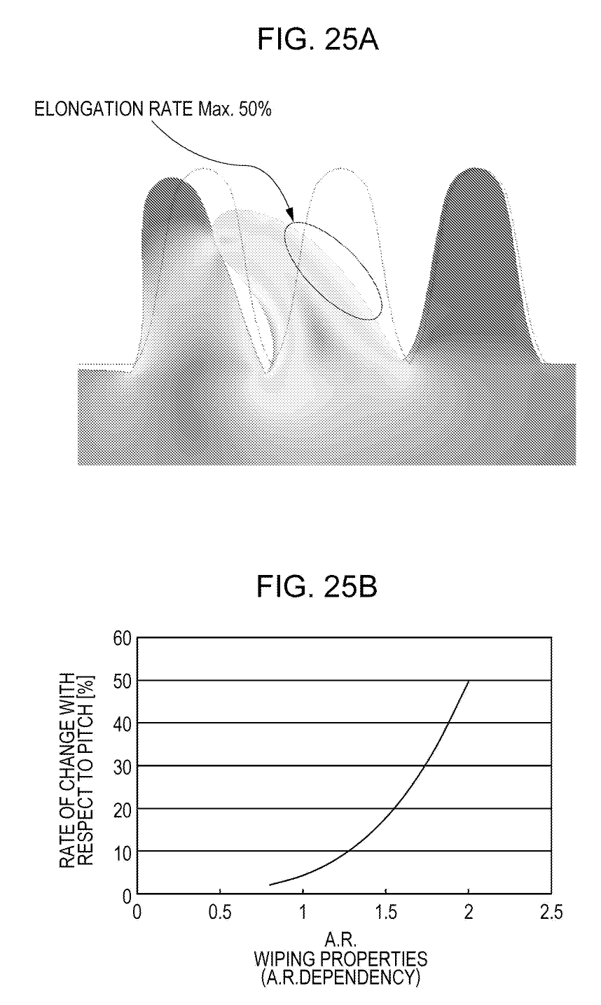

FIG. 25A is a diagram showing the results of a simulation in Test Example 6.

From the results of the simulation, it was found that the maximum value of the elongation rate when the apex portion of the central structure was brought into contact with a side surface of an adjacent structure was 50%.

Therefore, it is preferable that the elongation rate of the material of the structure be equal to or greater than 50% in order to cause the adjacent structures to come into contact or come into close contact with each other.

### Test Example 7

The rate of change ((ΔX/P)×100) (%) in the displacement ΔX of the apex of the structure with respect to the pitch P was determined by a simulation as described below.

First, an optical element as illustrated in FIG. 24 was set. The setting conditions of the optical element were described as follows. In addition, ANSYS Structural (produced by ANSYS, Inc.) was used as a program.

### Base Body

Thickness D: 750 nm

Elastic modulus: 100 MPa

### Nanostructure

Height: 250 nm

Pitch: 125 to 312.5 nm

Aspect ratio: 0.8 to 2.0

Number of structures: 3

Next, a weight was exerted on the structure located at the center, among three structures shown in FIG. 24. Specifically, a pressure of 7.5 MPa was applied to a region in a range of a height of 200 nm to 250 nm in one side surface of the central structure, and the rate of change ((ΔX/P)ₓ₁₀₀) (%) in the displacement ΔX of the apex of the structure with respect to the pitch P was obtained. At this time, the bottom surface was fixed. Here, the displacement ΔX of the structure refers to an amount of change in the apex of the structure in the X axis direction (refer to FIG. 24).

FIG. 25B is a graph showing the results of the simulation in Test Example 7. In FIG. 25B, the horizontal axis indicates the wiping performance (aspect ratio (A.R.) dependency), and the vertical axis indicates the rate of change in the displacement ΔX of the apex of the structure with respect to the pitch P.

As is clear from FIG. 25B, the wiping performance is enhanced as the rate of change in the displacement ΔX of the apex of the structure with respect to the pitch P increases. For example, at A.R.=1.2, the wiping performance is enhanced 1.6 times compared to that at A.R.=0.8.

It is thought that the causes of the enhancement in wiping performance are as described below.

(1) It is thought that the pitch width of the structures with respect to the height of the structures was relatively reduced due to an increase in aspect ratio, and the oil can be effectively pushed out even by a low degree of deformation of the nanostructure, so that the wiping performance was improved.

(2) It is thought that the nanostructure was enabled to be deformed by a smaller force due to an increase in aspect ratio and thus the wiping performance was enhanced.

### Test Examples 8-1 to 8-8

The luminous reflectance of the optical element was determined by an optical simulation on the basis of an RCWA method.

The conditions of the simulation were as described below.

Shape of structure: paraboloid shape

Arrangement pattern of structures: quasi-hexagonal lattice

Height of structure: 125 to 1250 nm

Arrangement pitch of structures: 250 nm

Aspect ratio of structure: 0.5 to 5

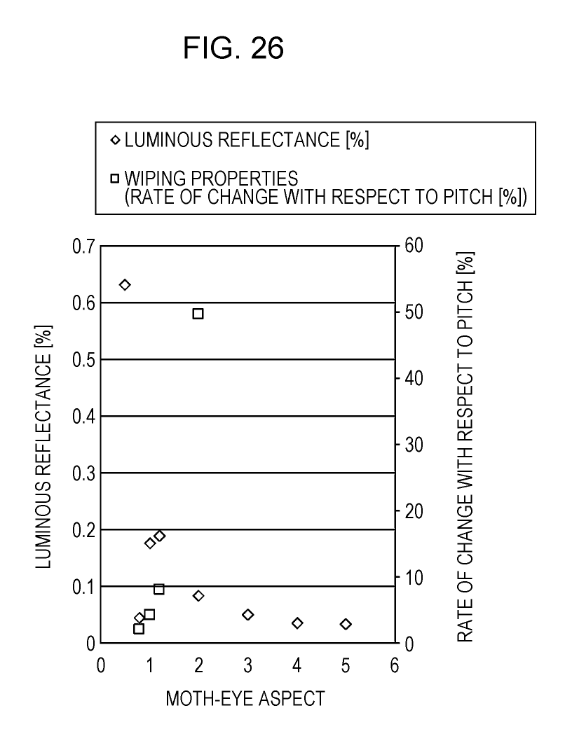

FIG. 26 is a graph showing the results of simulations in Test Examples 8-1 to 8-8. Table 14 shows the results of the simulations in Test Examples 8-1 to 8-8. In addition, the results of the simulation (wiping performance) in Test Example 7 are also shown in FIG. 26 and Table 14.

TABLE 14

| | TEST | TEST | TEST | TEST | TEST | TEST | TEST | TEST |
|---|---|---|---|---|---|---|---|---|
| | EXAMPLE | EXAMPLE | EXAMPLE | EXAMPLE | EXAMPLE | EXAMPLE | EXAMPLE | EXAMPLE |
| | 8-1 | 8-2 | 8-3 | 8-4 | 8-5 | 8-6 | 8-7 | 8-8 |
| ASPECT | 0.50 | 0.80 | 1.00 | 1.20 | 2.00 | 3.00 | 4.00 | 5.00 |
| LUMINOUS | 0.63 | 0.04 | 0.18 | 0.19 | 0.08 | 0.05 | 0.04 | 0.03 |
| REFLECTANCE | | | | | | | | |
| [%] | | | | | | | | |
| WIPING | — | 2.04 | 4.28 | 8.06 | 49.68 | — | — | — |
| PROPERTIES | | | | | | | | |

From FIG. 26 and Table 14, it was found that the reflection properties and the transmission characteristic tend to be degraded when the aspect ratio is less than 0.6, so that it is preferable that the aspect ratio be caused to be equal to or greater than 0.6 in order to enhance the optical properties and the wiping performance. However, according to the findings obtained by the present inventors through the experiments, it is preferable that, in consideration of the release properties during transfer in the state where the release properties are enhanced by performing fluorine coating on the master copy and adding a silicone-based additive or a fluorine-based additive to the transfer resin, the aspect ratio be set to be equal to or less than 5. Furthermore, in the case where the aspect ratio exceeds 4, there is no significant change in the luminous reflectance. Therefore, it is preferable that the aspect ratio be caused to be in a range of equal to or greater than 0.6 and equal to or less than 4.

### Example 5

On the surface in which titanium dioxide (with a particle size of 0.3 μm) was dispersed into, for example, 100 parts by mass of polyethylene terephthalate as a resin-coated layer on the surface of base paper having a thickness of 125 μm, a porous ceramic coating agent was applied as an ink storage layer, thereby preparing an ink jet sheet. In addition, after printing a still image on this sheet, a film obtained by transferring a moth-eye pattern on a TAC film having a base material thickness of 50 μm was adhered by an adhesive. In this manner, a photograph with an anti-reflection function was produced.

### Evaluation of Visibility

The photograph with an anti-reflection function of Example 5 obtained as described above was observed under a fluorescent lamp. In addition, a photograph without an optical element adhered was similarly observed. As a result, it was found that in a perspective view with an anti-reflection function, reflection of light from the fluorescent lamp was prevented, and thus visibility was significantly enhanced.

While the embodiments of the present disclosure have been described in detail, the present disclosure is not limited to the above-described embodiments, and various modifications based on the technical spirit of the present disclosure can be made.

For example, the configurations, methods, processes shapes, materials, the numerical values, and the like mentioned in the above-described embodiments are only examples, and if necessary, different configurations, methods, processes, shapes, materials, numerical values, and the like from those may also be used.

In addition, the configurations, methods, processes, shapes, materials, numerical values, and the like of the above-described embodiments can be combined with each other without departing from the gist of the present disclosure.

In addition, in the above-described embodiments, the case where the present disclosure is applied to the liquid crystal display apparatus is exemplified. However, the present disclosure can also be applied to various display apparatuses other than the liquid crystal display apparatus. For example, the present disclosure can be applied to various display apparatuses such as cathode ray tube (CRT) displays, plasma display panels (PDP), electro luminescence (EL) displays, and surface-conduction electron-emitter displays (SED). In addition, the present disclosure can also be applied to touch panels. Specifically, for example, the optical element according to the above-described embodiment can also be used as a base material provided on a touch panel and the like.

In addition, in the above-described embodiments, a peeping prevention function may be given to the optical element by changing the pitch of the structures appropriately, so as to generate diffracted light in the slanting direction with respect to the front.

In addition, in the above-described embodiments, a low-refractive index layer may be further provided on the surface of the base body on which the structures are formed. It is preferable that the low-refractive index layer mainly contain a material having a lower refractive index than those of the materials constituting the base body and the structures. Examples of materials of such a low-refractive index layer include organic materials such as fluorine-based resins and inorganic low-refractive index materials such as LiF and MgF₂.

In addition, in the above-described embodiments, the case where the optical element is produced from the photosensitive resin is exemplified. However, the production method of the optical element is not limited to these examples. For example, the optical element may be produced through thermal transfer or injection molding.

In addition, in the above-described embodiments, the case where the concave or convex structures are formed on the outer peripheral surface of the master copy having a columnar shape or a cylindrical shape is exemplified. However, in the case where the master copy has the cylindrical shape, concave or convex structures may be formed on the inner peripheral surface of the master copy.

In addition, in the above-described embodiments, the elastic modulus of the material constituting the structures may be caused to be equal to or greater than 1 MPa and equal to or less than 200 MPa and the aspect ratio of the structures may be caused to be equal to or greater than 0.2 and less than 0.6. Even in this case, stains such as fingerprints adhered to the surface of the optical element can be wiped off.

In addition, in the above-described embodiments, the case where the present disclosure is applied to the optical elements is exemplified. However, the present disclosure is not limited to these examples and the present disclosure can also be applied to fine structures other than the optical elements. As fine structures other than the optical elements, cell culture scaffolds, water-repellent glass using the lotus effect, and the like can be applied.

In addition, in the above-described embodiments, the elastic moduli of the base material, the basal layer, and the structure may be changed therein. For example, those elastic moduli may have distributions in the thickness direction of the base material, in the thickness direction of the basal layer, or in the height direction of the structure. In this case, the change in elastic modulus can be caused to be continuous or discontinuous.

The present disclosure contains subject matter related to that disclosed in Japanese Priority Patent Application JP 2011-023391 filed in the Japan Patent Office on Feb. 4, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. An optical element having an anti-reflection function comprising:
a base body having a surface; and
a plurality of structures arranged with fine pitches equal to or less than a wavelength of visible light on the surface of the base body,
wherein an elastic modulus of a material forming a structure in the plurality of structures is equal to or greater than 1 MPa and equal to or less than 1200 MPa,
an aspect ratio of the structure is equal to or greater than 0.6 and equal to or less than 5, and
a coefficient of kinetic friction of the surface of the base body on which the plurality of structures are formed is equal to or less than 0.85.

2. The optical element according to claim 1, wherein the structure contains silicone and urethane.

3. The optical element according to claim 1, wherein the structure is made of a polymer of an energy ray-curable resin composition containing silicone acrylate and urethane acrylate.

4. The optical element according to claim 1, the elastic modulus of the material forming the base body is equal to or greater than 1 MPa and equal to or less than 3000 MPa.

5. The optical element according to claim 4, wherein a thickness of the base body is equal to or greater than 60 μm.

6. The optical element according to claim 1, further comprising a basal layer between the plurality of structures and the base body,
wherein an elastic modulus of the basal layer is equal to or greater than 1 MPa and equal to or less than 3000 MPa.

7. The optical element according to claim 6, wherein a thickness of the basal layer is equal to or greater than 60 μm.

8. The optical element according to claim 1, further comprising a basal layer between the plurality of structures and the base body,
wherein elastic moduli of the basal layer and the base body are equal to or greater than 1 MPa and equal to or less than 3000 MPa.

9. The optical element according to claim 8, wherein a total thickness of the basal layer and the base body is equal to or greater than 60 μm.

10. The optical element according to claim 1, wherein an elongation rate of the material forming the structure is equal to or greater than 50%.

11. The optical element according to claim 1, wherein an elongation rate of the material forming the base body is equal to or greater than 20%.

12. The optical element according to claim 1, further comprising a surface treatment layer formed on the structures,
wherein the surface treatment layer contains at least one of fluorine and silicon, and
a contact angle of an oleic acid in the surface of the structure having the surface treatment layer formed thereon is equal to or greater than 30 degrees.

13. The optical element according to claim 1,
wherein the plurality of structures are arranged to constitute a plurality of rows of tracks on the surface of the base body and form a hexagonal lattice pattern, a quasi-hexagonal lattice pattern, a tetragonal lattice pattern, or quasi-tetragonal lattice pattern, and
the structure has an elliptical cone shape or a truncated elliptical cone shape with a major axis direction in an extension direction of the track.

14. The optical element according to claim 1,
wherein the plurality of structures are arranged to constitute a plurality of rows of tracks on the surface of the base body, and
the track has a straight line shape or an arc shape.

15. The optical element according to claim 14, wherein the tracks meander.

16. An optical element having an anti-reflection function, the element comprising:
a plurality of structures arranged with fine pitches equal to or less than a wavelength of visible light,
wherein lower portions of adjacent structures are connected to each other,
an elastic modulus of a material forming a structure in the plurality of structures is equal to or greater than 1 MPa and equal to or less than 1200 MPa,
an aspect ratio of the structure is equal to or greater than 0.6 and equal to or less than 5, and
a coefficient of kinetic friction of surfaces of the plurality of structures arranged with the fine pitches is equal to or less than 0.85.

17. A display apparatus including the optical element according to claim 1.

18. An information input apparatus including the optical element according to claim 1.

19. A photograph including the optical element according to claim 1.

20. A production method of an optical element having an anti-reflection function, the method comprising:
causing an energy ray-curable resin composition to come into close contact with a master copy, and illuminating the energy ray-curable resin composition with an energy ray to be cured; and
peeling the cured energy ray-curable resin composition from the master copy, thereby forming a plurality of structures arranged with fine pitches equal to or less than a wavelength of visible light on a surface of a base body,
wherein an elastic modulus of a material forming a structure in the plurality of structures is equal to or greater than 1 MPa and equal to or less than 1200 MPa,
an aspect ratio of the structure is equal to or greater than 0.6 and equal to or less than 5, and
a coefficient of kinetic friction of the surface of the base body on which the plurality of structures are formed is equal to or less than 0.85.

21. A production method of an optical element having an anti-reflection function, the method comprising:
causing an energy ray-curable resin composition to come into close contact with a master copy, and illuminating the energy ray-curable resin composition with an energy ray to be cured; and
peeling the cured energy ray-curable resin composition from the master copy, thereby forming a plurality of structures arranged with fine pitches equal to or less than a wavelength of visible light,
wherein lower portions of adjacent structures are connected to each other,
an elastic modulus of a material forming a structure in the plurality of structures is equal to or greater than 1 MPa and equal to or less than 1200 MPa,
an aspect ratio of the structure is equal to or greater than 0.6 and equal to or less than 5, and
a coefficient of kinetic friction of surfaces of the plurality of structures arranged with the fine pitches is equal to or less than 0.85.
